(19) United States
(12) Patent Application Publication
(10) Pub. No.: US 2018/0247549 A1
(43) Pub. Date: Aug. 30, 2018

(54) DEEP ACADEMIC LEARNING INTELLIGENCE AND DEEP NEURAL LANGUAGE NETWORK SYSTEM AND INTERFACES

(71) Applicant: SCRIYB LLC, MANASSAS, VA (US)

(72) Inventors: Scott Mckay Martin, Fairfax Station, VA (US); James R. Casey, Fairfax, VA (US); Christopher Etesse, Paeonian Springs, VA (US)

(73) Assignee: SCRIYB LLC, Manassas, VA (US)

(21) Appl. No.: 15/901,476

(22) Filed: Feb. 21, 2018

Related U.S. Application Data
(63) Continuation-in-part of application No. 15/686,144, filed on Aug. 24, 2017.
(60) Provisional application No. 62/461,757, filed on Feb. 21, 2017.

(51) Int. Cl. G09B 5/02; G06N 3/08; G06N 7/00; G09B 7/06; G09B 7/02

(52) U.S. Cl. CPC G09B 5/02; G06N 3/08; G09B 7/02; G09B 7/06; G06N 7/005

(57) ABSTRACT

A knowledge acquisition system and artificial cognitive declarative memory model to store and retrieve massive student learning datasets. A Deep Academic Learning Intelligence system for machine learning-based student services provides monitoring and aggregating performance information and student communications data in an online group learning course. The system uses communication activity, social activity, and the academic achievement data to present a set of recommendations and uses responses and post-recommendation data as feedback to further train the machine learning-based system.

### CROSS-REFERENCE TO RELATED APPLICATIONS

The present application claims priority to previously filed U.S. Provisional Application No. 62/461,757, filed Feb. 21, 2017, entitled DEEP LEARNING INTELLIGENCE SYSTEM AND INTERFACES, Martin et al., and is a continuation-in-part of U.S. patent application Ser. No. 15/686,144, filed Aug. 24, 2017, entitled AN ARTIFICIAL COGNITIVE DECLARATIVE-BASED MEMORY MODEL TO DYNAMICALLY STORE, RETRIEVE, AND RECALL DATA DERIVED FROM AGGREGATE DATASETS, Martin et al, both of which are incorporated herein by reference in their entirety.

### FIELD OF THE INVENTION

The invention relates to network-based systems and methods for monitoring user behaviors and performances and aggregating behavior and performance related data into workable data sets for processing and generating recommendations. The invention also relates to use of natural language processing, neural language processing, logistic regression analysis, clustering, machine learning including use of training data sets, and other techniques to transform aggregated data into workable data sets and to generate outputs. The invention also relates to use of user interfaces for receiving data and for presenting interactive elements. More particularly, the invention relates to academic institution services for tracking student behavior and performance information related to and affecting scholastic achievement. The invention also relates to systems for monitoring electronic communications of students participating in online group learning courses conducted electronically via a network.

### BACKGROUND OF THE INVENTION

Recently, computer-based, network-driven delivery and interaction platforms have been implemented in not only commercial and business sectors but also in education. With the conversion of vast amounts of previously published print materials into electronic form and the increasing publication of new content in electronic form, much of the content relied on in educational settings is more widely and more readily available to both students and teachers. Moreover, some subject matter more naturally lends itself to electronic delivery and group interaction, e.g., gaming technology courses. Combining widespread availability of electronic content with performance enhancing computer-based functions has resulted in an increasing movement to delivering courses, in whole or in part, via online environments. However, beyond delivery of course materials and resources, other drawbacks limit the effectiveness of such systems.

For example, in the field of education pre-determined and ad hoc learning achievement criteria, goals, and objectives are assigned by a teacher at the beginning of an academic term for all students. Historically, these expectations are generally conveyed in a course syllabus or course outline at the beginning of a term. As students academically progress through a physical or synchronous virtual classroom, assessments and grades assigned, based on the syllabus content, are summed up (or curved based on the highest grade in the course) to provide a final achievement mark that indicates a student's understanding and level of mastery of the subject matter taught. One problem associated with this approach to education services is there is no other tracking mechanism, other than traditional marks assigned post assignment, quiz, or test, within an active classroom structure to inform or alert an instructor during the course term of a student not comprehending material covered and/or not understanding that a certain level of mastery is required to succeed in the next level of the subject matter.

New technologies have made online and/or “eLearning” delivery systems increasingly popular alternatives and supplements to traditional classroom instruction and training. Benefits of eLearning include: lower costs and increased efficiencies in learning due to reduced overhead and recurring costs; the ability for students to learn at their own pace (as opposed to the pace of the slowest member of their class); the option for students to skip elements of a program that they've already mastered; and decreased student commuting time, among others.

However, the ease with which eLearning programs may be delivered to large groups of students and the attractiveness to administrators of reducing costs, have led to the negative effect of large class sizes, which typically results in less student engagement, and gives the appearance of a lack of attention to individual students. In addition, although some eLearning programs may offer smaller class sizes or even small group learning units within a larger overall class, the composition of student groupings may not facilitate effective learning (e.g., if group members are geographically far from one another, if group members do not have backgrounds, skills, or interests that complement or supplement one another, etc.). Courses offered via eLearning programs are also typically managed by an institution, limiting individual instructors (e.g., instructors that are not employed by specific institutions) from creating and managing their own courses. These and other drawbacks presently exist and are frustrating eLearning opportunities.

One system directed to virtual student grouping used in online group learning environments based on divergent goals of diversity vs. similarity depending on criteria applied to achieve enhanced outcomes is disclosed in U.S. patent application Ser. No. 14/658,997 (Martin), entitled “System and Method for Providing Group Learning Via Computerized Student Learning Assignments Conducted Based on Student Attributes and Student-Variable-Related Criteria,” issued as U.S. Pat. No. 9,691,291 on Jun. 27, 2017, (the “'997 application”) the entirety of which is hereby incorporated by reference. The system disclosed in the '997 application, among other things, captures real-time performance related data as well as personal attribute data and assigns students to student groups in online learning courses based on attributes and course criteria to achieve student diversity with respect to a first criteria and student similarity with respect to a second criteria and may be used in connection with the present invention as described below.

One further system directed to monitoring student performance and aggregating data for re-grouping of students in group learning environments to achieve enhanced outcomes is disclosed in U.S. patent application Ser. No. 15/265,579 (Martin), entitled “Networked Activity Monitoring Via Electronic Tools in an Online Group Learning Course and Regrouping Students During the Course Based on The Monitored Activity,” (the “'579 application”) the entirety of which is hereby incorporated by reference. The system disclosed in the '579 application provides active performance tracking and analysis to regroup students within a synchronous or asynchronous virtual classroom based on predetermined academic criteria during a course term, e.g., module, academic quarter, term, or year of study. The '579 application discloses a methodology for analyzing additional measurable attributes. For example, learning attributes associated with the established fields of Social Learning Theory (e.g., as descried in publicly available literature such as authored by Albert Bandura), Peer-to-Peer cohort learning, and Group- or Team-Based Learning (e.g., as descried in publicly available literature such as authored by Larry K. Michaelsen) may be measured and analyzed. Based on collected data related to student learning attributes, the system of the '579 application generates outputs that may be used, including in combination with traditional grading mechanisms, to regroup students and positively influence student academic outcomes. The system disclosed in the '579 application provides some ability to assess, during a course term, how a student is progressing in an online group learning course. The '579 system also monitors networked activity that occurs during a course term to assess a student's performance during the course term. The '579 system overcomes technical problems that limited prior assessment capabilities. For example, in chat sessions with multiple users (including, in an online group learning context, one or more instructors, and students), the '579 system better tracks and captures data related to inter-group communications, e.g., linking messages and identifying recipients of chat messages from senders in multi-user chat message systems. Previously, the transient nature of chat messaging limited performing analytics on such messaging and prior online learning systems typically failed to capture or consider real-time academic achievement activity and social connections between users participating in a course. The techniques disclosed in the '579 application provide improved analytic and diagnostic capabilities for measuring and enhancing student understanding of taught subject matter and may be used in connection with the present invention as described below.

Notwithstanding the aforementioned advancements, over time, these critically important big data (sets) are never parsed and combed. No system exists that is capable of delineating and uncovering at the individual student level how individual communication methodologies, styles, and tendencies, particularly when combined with social and interpersonal behavioral attributes within a particular academic environment, or outside an academic (synchronous or non-synchronous) classroom, may influence and affect subject matter comprehension and academic performance. The need exists for a system capable of providing mid-course instructional correction assistance beyond traditional in-class subject matter testing/questions/answers and beyond traditional “outside of class” office hour meetings between individual students and their single-subject instructors. Moreover, even traditional in-person academic help is limited and fails to account for many attributes at the individual student level, including communication styles, social and interpersonal behavioral attributes, external personal conditions and environmental issues. What is needed is a system that combines academic expectations and performance tracking with monitoring and tracking of a wide-range of student personal attributes to deliver desired additional instructional resources (advising, counseling, mentoring) to enhance and improve the learning experience and student performance and development. Accordingly, the aforementioned shortcomings as well as other drawbacks exist with conventional online learning systems.

### SUMMARY OF THE INVENTION

The invention addresses these and other drawbacks by providing a Deep Academic Learning Intelligence (DALI) for machine learning-based Student Academic Advising (AA), Professional Mentoring (PM), and Personal Counseling (PC) based on Massively Dynamic Group Learning academic performance history, subject-based and non-subject based communication content understanding, and social and interpersonal behavioral analysis. The invention also provides a personalized learning map (PLM) and various user interfaces to input, capture, output and present data and high function elements related to achieving the goals of the enhanced student learning environment provided by the DALI system. Electronic communication pathways, such as chat function, email, video, etc., have enhanced the effectiveness of group learning in online environments and opened the door to monitoring of such activities making data related to such activities available to the DALI system.

In one embodiment, the DALI system monitors and aggregates, via a network, performance information that indicates scholastic achievement and electronic communications of students participating in an online group learning course, conducted electronically via the network during a course term, in which the students in a given course are grouped, and potentially regrouped over time, based on monitored attributes and criteria. Each group of students represents an idealized virtual classroom in which members of a given group collectively represent an ideal or optimized makeup of students based on their characteristics as applied against a set of criteria or rules as may be established using machine-learning processes. Several features included in the DALI system that were not present in prior systems include Student Academic Advising, Professional Mentoring, and Personal Counseling. These features are provided in a Massively Dynamic Group Learning environment.

By taking into account academic performance history, subject-based and non-subject based communication content understanding, and social and interpersonal behavioral analysis, the DALI system provides an intelligent system that “learns” about each student's evolving internal (academic) and external conditions, short-term and long-term factors, and personal expectations over time, and, based on this data, applies rules and algorithms to determine and present appropriate corrective suggestions and recommendations to improve overall academic performance. The DALI also tracks student response and responsiveness to the presented suggestions and recommendations to track efficacy of the solution. For example, the DALI presents users with suggestions and recommendations via a user interface that includes interface elements designed to receive student responses to the recommendation (e.g., tick boxes, check boxes, radio buttons, or other input elements identified as “I agree to recommendation” and “I do not agree with recommendation”) as to whether the student agrees, or not, to abide by the recommendation. The DALI tracks student responsiveness by tracking actual student performance after suggestions/recommendations are made to determine improvement or not, e.g., by tracking direction of academic performance—are grades higher or lower, is participation increasing or decreasing. In effect, data obtained related to the recommendations and suggestions are captured and input as a feedback into the machine learning system to fine-tune parameters, rules and processes to improve performance over time.

In one exemplary manner of operation, upon an extended period of learning, DALI will create an evolving student's Personal Learning Map (PLM) comprised of external and internal (virtual classroom) student actions, inactions, and activities, and interpolate, fuse, and integrate these student actions, inactions, and activities. The PLM collects all this socially shared data via a synchronous or asynchronous classroom environment interface.

Based on these ever-changing variables, DALI makes active and dynamic academic course corrective suggestions and recommendations and delivers same to the individual student. Based on student attributes and collected data and criteria as well as rules-based processes, DALI provides an academic advising (AA) facility that interacts directly with students and may be part of the recommendation process. The AA facility in effect provides an academic umbrella including academic major advice and other academic pathway advice. Based on student attributes and collected data (both internal and external, academic and non-academic) and criteria as well as rules-based processes, DALI provides one or both of a Professional Mentoring (PM) function and a Personal Counseling (PC) function. Some data may be particular for use by each function while other data has overlapping value and is used by more than one such function. The PC and/or PM functions intervene, potentially at academic or professional points of stress or conflict, to provide professional mentoring involving wisdom (learned) and advice on ways to improve their academic and/or professional pathway. This may include breaking or altering detrimental habits and conduct and/or promoting positive, helpful activities. For example, the DALI PC/PM function(s) may identify poor study or other personal habits and ways to positively adjust demeanor, attitude, time management skills, communication styles, and interpersonal behaviors to improve professional or academic performance and development.

Again, the invention is not limited to use in academic environments and may be used, for example, to track and improve or manage employees or professionals in a work setting, e.g., to improve professional traits to ensure success and professional development. In addition, the DALI can be used to assist a student in a chosen professional pathway. Aspects of the invention could be used, for example, in a Six Sigma-type process to identify activities that present defects or problems in an overall process and suggest and implement ways to correct such defects or problems, i.e., problems associated with student behavior and study habits may be considered a type of defect in the process of learning and delivery of education services.

Returning to the academic environment, the DALI PC function may be used to intervene, during the academic experience, to provide personal counseling about specific external (non-subject) issues and events that may be negatively affecting academic performance. These issues, socially shared via a synchronous or asynchronous classroom environment with other students and/or with instructor(s), may involve personal and intimate relationships, family issues, financial pressures and concerns, legal conflicts, and other external variables that may be negatively affecting academic performance. In addition, data related to student condition may be accessed through other available databases, e.g., court and criminal records, such as a DUI (Driving Under the Influence) charge, tax delinquency, financial databases, media content, etc. Such other sources may be made available as public or as authorized by the individual student. Depending on the choices made from the recommendations and suggestions provided, and the resultant academic performance post suggestions and recommendations, each student's personal learning map will morph and change, allowing DALI to “learn” about the “value” of each suggestion and recommendation to provide better and more relevant recommendations, advice, and counsel to offer each student in the future.

In a further aspect the present invention provides a highly effective knowledge acquisition system (KAS) utilizing a new memory model to provide enhanced personal learning maps, referred to herein as personal learning map (PLM) and entity-specific learning map and “Omega” learning map (ΩLM). The KAS provides a unique approach to storing and retrieving massive learning datasets, e.g., student-related datasets, within an artificial cognitive declarative memory model. This new memory storage model provides improved and useful storage and retrieval of the immense student data derived from utilizing multiple interleaved machine-learning artificial intelligence models to parse, tag, and index academic, communication, and social student data cohorts as applied to academic achievement, that is available to capture in an Aggregate Student Learning (ASL) environment. In addition, the declarative memory model may include the additional feature of an artificial Episodic Recall Promoter (ERP) module also stored in long-term and/or universal memory modules, to assist students with recall of academic subject matter as it relates to knowledge acquisition.

In one implementation, the KAS and related Omega Learning Map (ΩLM) and memory models write and retrieve (store and access) student learning datasets available from Aggregate Student Learning (the collection and consideration of academic and non-academic communication and social data together) associated with Deep Academic Learning Intelligence (DALI) System and Interfaces. DALI's DNLN AI models parses these immense datasets utilizing artificial cognitive memory models that includes Working Memory (buffer) and a Short-Term Memory (STM) model that includes a unique machine learning (ML) trained entropy function to decipher, identify, tag, index, and store subject (academic) and non-subject communication and social data. Moreover, DALI stores relevant, important, and critical singular earning and learning and social cohort datasets in the appropriate ΩLM Declarative Memory (Sub-Modules) for later retrieval. Further, the ΩLM stored datasets, singular and (integrated) cohorts, provide DALI the sources for dynamic regrouping of students into a more conducive academic environment, corrective academic and social suggestions and recommendations, as well as episodic memory information for the academic context recall assistance ERP apparatus.

In a first embodiment the present invention provides a system for monitoring and aggregating, via a network, academic performance information and social non-academic performance information derived from electronic communications of students participating in an online group learning course during a course term and generating a set of student remedial recommendations specific to individual students, the system comprising: a computer system comprising one or more physical processors adapted to execute machine readable instructions stored in an accessible memory, the computer system adapted to: collect data related to a group of students and organize data into a set of historical data sets, and group students for an online group learning course based in part on the organized data; generate a first personal learning map (PLM) comprising data sets for a first student based on a first historical data set associated with the first student; during the course term, collect additional data related to the first student and organize the additional data into a first current data set and update the first PLM based on the first current data set, the additional data collected related to both academic subject matter related activity and non-academic subject matter related activity; apply the first PLM data sets as inputs to a Deep Neural Language Network (DNLN) and generate as outputs from the DNLN a first set of recommendations for presenting to the first student; generate a first student user interface comprising the first set of recommendations and a first set of user response elements; transmit, via a network, the first student user interface to a machine associated with the first student; and receive a signal representing a user response to the first set of recommendations.

The system of the first embodiment may further be adapted to update the first PLM to reflect the received user response. The computer system may further be adapted to input data from the first PLM including data related to the first set of recommendations and the received user (student) response as feedback into a machine-learning process associated with the DNLN. The computer system may further be adapted to calculate hidden layer errors in the DNLN and alter the DNLN based on the user (student) feedback. The computer system may further be adapted to alter the DNLN by changing weights associated with one or more hidden layers. The system may further comprise a set of student remediation modules including one or more of academic advising, professional mentoring, and personal counseling, and wherein the set of recommendations relates to one or more of the student remediation modules. The collected data may include data collected and entered manually through a user interface in communication with the computer system, the user interface being operated by one or more of a student, a teacher, an academic advisor, a counselor, or mental health administrator. The computer system may employ one or more of the following techniques: logistic regression analysis, natural language processing, softmax scores utilization, batching, Fourier transform analysis, pattern recognition, and computational learning theory. The computer system may be further adapted to: generate a second student user interface comprising a second set of user response elements; transmit, via a network, the second student user interface to a machine associated with the first student; and receive a signal representing a user response to the second set of recommendations. The first set of recommendations may comprise remedial recommendations. The first set of recommendations may comprise intervention recommendations. The additional data may comprise aggregate student learning data. The aggregate student learning data may comprise a set of communication information derived from a set of conversations and interactions between the first student and a set of other users. The computer system may be trained using a machine learning process on a set of input data, the set of input data comprising one or more selected from the group consisting of: a set of course syllabuses, and a set of course textbooks, a set of structured English language datasets, and a set of unstructured English language datasets. The computer system may be trained using a machine learning process on a set of input data, the set of input data comprising one or more selected from the group consisting of: a set of structured English language datasets, and a set of unstructured English language datasets. The set of structured English language datasets may comprise a slang language dataset. The computer system may be trained using an unsupervised active training process, wherein input for the unsupervised active training process is provided by real-time student subject communication monitoring and social interactivity content understanding. The user response to the first set of recommendations may comprise one selected from the group consisting of: “Yes I will!”, “No Thanks.”, “Maybe.”, and “Ignore.” The second student user interface may comprise a set of feedback user interface elements, the set of feedback user interface elements comprising a “Was this Helpful” input and a “Why” input. The first personal learning map (PLM) may further comprise: a sensory memory module adapted to receive and store semantic input datasets and episodic input datasets; a working memory module adapted to receive datasets from the sensory memory module; a short-term memory module adapted to receive classified datasets from the working memory module; and a declarative memory module adapted to receive datasets from one or both of the working memory module and the short-term memory module.

In a second embodiment the invention provides a knowledge acquisition system (KAS) for dynamically storing and retrieving aggregated datasets, the system comprising: a computer system comprising one or more physical processors adapted to access datasets and execute machine readable instructions stored in a memory; a sensory memory module adapted to receive and store semantic input datasets and episodic input datasets; a working memory module adapted to receive datasets from the sensory memory module and comprising an information classifier adapted to classify datasets received from the sensory memory module and direct classified datasets to respective destinations; a short-term memory module adapted to receive classified datasets from the working memory module and to determine an importance for each of the received classified datasets, the short-term memory module adapted to pass classified datasets to a desired destination based upon comparing determined importance of the classified datasets with a defined criterion; and a declarative memory module adapted to receive datasets from one or both of the working memory module and the short-term memory module and comprising a semantic memory and an episodic memory for storing, respectively, received classified semantic datasets and classified episodic datasets, the declarative memory comprising a set of entity-specific data maps each comprising datasets associated with a respective entity.

The second embodiment may be further characterized as follows: wherein for each dataset received by the working memory module, the information classifier is adapted to direct the working memory module to perform one of two operations: push the dataset to the short-term memory module; or push the dataset directly to the declarative memory module; wherein the information classifier is adapted to classify datasets using a vector topology of categories and sub-variables, wherein W1(Cat1) and W2(Cat2), respectively represent vectors (W1a, W1b, W1c, . . . , W1n) and (W2a, W2b, W2c, . . . , W2n), where Cat1 represents a first category and Cat 2 represents a second category, different than the first category, and a-n represents a set of sub-variables, collectively representing classified datasets; wherein the probability to classify sub-variable datasets for a given category vector W1 is p (Ck|W1)=(p(Ck)p(W1|Ck))/p(W1), where k is the possible outcomes of classification and C is the sub-variable group; wherein the working memory module is adapted to pass classified semantic input datasets directly to the declarative memory module and to pass classified episodic input datasets to the short-term memory; wherein the short-term memory module is further adapted to utilize weights altered by a set of factors to determine entropy of classified episodic input datasets and to forget classified episodic input datasets having a determined entropy that fails to satisfy a predetermined criterion; wherein the information classifier is adapted to interpret Natural Language Analysis and Processing (NPL) data; wherein the semantic input datasets and episodic input datasets stored in the sensory memory module comprise datasets processed using NPL including one or more of parsing, tagging, timestamping, or indexing data; further comprising a procedural memory module adapted to store for execution instruction sets representing one or more sets of rules for use by one or more of the memory modules; further comprising an episodic recall prompt generator adapted to generate, based on information associated with a first user received from the episodic memory, an online user interface experience designed to promote in the first user a experiential recall; wherein the online user interface experience represents a multi-sensory associative exposure; further comprising an online learning system adapted to monitor and aggregate, via a network, academic performance information and information derived from electronic communications of students participating in an online group learning course during a course term and generating a set of recommendations specific to individual students, the online learning system comprising: a universal memory bank storing data related to a group of students and organized into a set of historical data sets, and group students for an online group learning course based in part on the organized data; and wherein a first entity-specific data map stored in the declarative memory module represents a first personal learning map (PLM) comprising data sets for a first student based on a first historical data set associated with the first student; wherein, during a course term, the online learning system collects, organizes and stores additional data related to the first student in the universal memory bank, and updates and revises the first PLM based on the additional data, the additional data being related to both academic subject matter related activity and non-academic subject matter related activity; wherein the online learning system is further adapted to apply the first PLM data sets as inputs to a Deep Neural Network (DNN) and generate as outputs from the DNN a set of recommendations for presenting to the first student; wherein the online learning system is further adapted to: generate a first student user interface comprising the first set of recommendations and a set of user response elements; transmit, via a network, the first student user interface to a machine associated with the first student; and receive a signal representing a user response to the first set of recommendations; wherein the online learning system is further adapted to update the first PLM to reflect the received user response; wherein the online learning system is further adapted to input data from the first PLM including data related to the first set of recommendations and the received user response as feedback into a machine learning process associated with the knowledge acquisition system; wherein the online learning system further comprises a set of student services modules including one or more of academic advising, professional mentoring, and personal counseling, and wherein the set of recommendations relates to one or more of the student services modules; wherein the online learning system employs one or more of the following techniques: logistic regression analysis, natural language processing, fast Fourier transform analysis, pattern recognition, and computational learning theory.

In a third embodiment, the present invention provides a knowledge acquisition system for dynamically storing and retrieving aggregated datasets, the aggregated datasets including historical datasets representing academic performance information and information derived from electronic communications of students participating in an online group learning course, the system comprising: a computer system comprising one or more physical processors adapted to access datasets and execute machine readable instructions, the computer system further adapted to: collect data related to a group of students and organize data into a set of historical data sets; generate a first personal learning map (PLM) comprising data sets for a first student based on a first historical data set associated with the first student; apply the first PLM data sets as inputs to a Deep Neural Network (DNN) and generate as outputs from the DNN a set of recommendations for presenting to the first student; generate a first student user interface comprising the first set of recommendations and a set of user response elements; transmit, via a network, the first student user interface to a machine associated with the first student; and receive a signal representing a user response to the first set of recommendations; a sensory memory module adapted to receive and store semantic input datasets and episodic input datasets; a working memory module adapted to receive datasets from the sensory memory module and comprising an information classifier adapted to classify datasets received from the sensory memory module and direct classified datasets to respective destinations; a short-term memory module adapted to receive classified datasets from the working memory module and to determine an importance for each of the received classified datasets, the short-term memory module adapted to pass classified datasets to a desired destination based upon comparing determined importance of the classified datasets with a defined criterion; and a declarative memory module adapted to receive datasets from one or both of the working memory module and the short-term memory module and comprising a semantic memory and an episodic memory for storing, respectively, received classified semantic datasets and classified episodic datasets, the declarative memory comprising a set of personal learning maps, including the first PLM, each comprising datasets associated with a respective student from the group of students; and a Universal Memory Bank module adapted for the storage and retrieval of recommendation data related to received recommendation response signals from the group of students.

In another embodiment, the present invention provides a computer-implemented method for monitoring and aggregating, via a network, academic performance information and social non-academic performance information derived from electronic communications of students participating in an online group learning course during a course term and generating a set of student remedial recommendations specific to individual students, the method comprising: collecting, by a computer system comprising one or more physical processors adapted to execute machine readable instructions stored in an accessible memory, data related to a group of students; organizing, by the computer system, data into a set of historical data sets; grouping, by the computer system, students for an online group learning course based in part on the organized data; generating, by the computer system, a first personal learning map (PLM) comprising data sets for a first student based on a first historical data set associated with the first student; collecting during the course term, by the computer system, additional data related to the first student; organizing, by the computer system, the additional data into a first current data set; updating, by the computer system, the first PLM based on the first current data set, the additional data collected related to both academic subject matter related activity and non-academic subject matter related activity; applying, by the computer system, the first PLM data sets as inputs to a Deep Neural Language Network (DNLN); generating, by the computer system, as outputs from the DNLN a first set of recommendations for presenting to the first student; generating, by the computer system, a first student user interface comprising the first set of recommendations and a first set of user response elements; transmit, by the computer system via a network, the first student user interface to a machine associated with the first student; and receiving, by the computer system, a signal representing a user response to the first set of recommendations.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram illustrating a system for providing Deep Academic Learning Intelligence (DALI) for machine learning-based Student Academic Advising, Professional Mentoring, and Personal Counseling based on Massively Dynamic Group Learning academic performance history, subject-based and non-subject based communication content understanding, and social and interpersonal behavioral analysis, according to a first embodiment of the invention.

FIG. 2 is a schematic diagram illustrating use of the DALI system in connection with a virtual online student grouping system in accordance with the invention.

FIG. 3 illustrates an exemplary semantic, behavior-distributed representation map in accordance with the invention.

FIG. 4 is a block-flow diagram related to a dynamic student Personal Learning Map (PLM) in connection with the DALI recommendation process in accordance with the invention.

FIG. 5 is an exemplary representation of a set of user interface elements for use in presenting and capturing recommendation related information in accordance with the invention.

FIG. 6 is an exemplary representation of a Deep Neural Network (DNN) in accordance with the invention.

FIG. 7 is an exemplary representation of a DNN Matrix×Matrix algorithmic back propagation methodology in accordance with the invention.

FIG. 8 is an exemplary representation of a DALI having a DNN and PLM suggestion/recommendation loop input in accordance with the invention.

FIG. 9 is an exemplary block-flow diagram associated with the recommendation loop in accordance with the invention.

FIG. 10 is a schematic diagram illustrating a matrix weighting configuration of the DALI/Deep Neural (Language) Network/PLM in accordance with the invention.

FIG. 11 is a flow diagram representing an exemplary DALI method in accordance with the invention.

FIG. 12 is a schematic diagram of DALI Dataflow and ΩLM in accordance with one embodiment of the present invention.

FIG. 13 is a schematic diagram of the Knowledge Acquisition System and Memory Model in accordance with the present invention.

FIG. 14 is a schematic diagram of Sensory Memory Module (v) in the Knowledge Acquisition System (KAS).

FIG. 15 is a schematic diagram of Working Memory Module in the KAS.

FIG. 16 is a schematic diagram of Information Classifiers for W in the Working Memory Module.

FIG. 17 is a schematic diagram of Short-Term Memory (STM) Module in the KAS.

FIG. 18 is a schematic diagram of Entropy Filter and Decision Process in the STM.

FIG. 19 is a schematic diagram of Long-Term Memory Module (LTM) including Declarative Memory Module (DMM) in the KAS.

FIG. 20 is a schematic diagram of Episodic Memory Cell Model of the DMM.

FIG. 21 is a schematic diagram of DALI's Declarative Episodic Memory Blocks and Cells Structure in accordance with the DMM.

FIG. 22 is a schematic diagram of Procedural Memory Module Description of the LTM.

FIG. 23 is a schematic diagram of the Universal Memory Bank and DALI Suggestion/Helpful Training Loop in accordance with one implementation of the invention.

FIG. 24 is a schematic diagram of Historical Singular Learning Experience Data being Utilized as an ERP to Assist a Student with LTM Recall.

FIG. 25 is a schematic diagram of one exemplary DALI and ΩLM Integration.

FIG. 26 is a schematic diagram of DALI and multiple ΩLM integration.

FIG. 27 is an example of DALI parsed sentences from an exchange between two students.

FIG. 28 is an exemplary representation of a set of user interface elements for use in presenting and capturing recommendation related information in accordance with the invention.

FIG. 29 is a schematic diagram of the Universal Memory Bank and DALI advising recommendation and learner active training feedback in accordance with one implementation of the invention.

FIG. 30 is a block diagram illustrating five primary personality traits used by DALI to provide personalized recommendations.

FIG. 31 is an exemplary representation of a DALI having a DNN and PLM suggestion/recommendation loop input in accordance with the invention.

### DETAILED DESCRIPTION OF THE INVENTION

The invention described herein relates to a system and method for providing Deep Academic Learning Intelligence (DALI) for machine learning-based Student Academic Advising, Professional Mentoring, and Personal Counseling based on Massively Dynamic Group Learning academic performance history, subject-based and non-subject based communication content understanding, and social and interpersonal behavioral analysis. The DALI system includes components for monitoring and aggregating, via a network, performance information that indicates scholastic achievement and electronic communications of students participating in an online group learning course, conducted electronically via the network during a course term. The performance information may indicate a performance of a student in the course. The system may provide electronic tools to users. The system may monitor the tools to determine communication and social activity, as well as academic achievement of the students. The communication activity, social activity, and the academic achievement may be used to dynamically regroup students during a course term. Although the invention is described herein in the connection with online course offerings and student groupings and monitoring of student attributes, this is done solely to describe the invention. The invention is not limited to the particular embodiments and uses described herein. For instance, instead of students the processes could be used to monitor teacher-related data and to provide recommendations to teachers for ways to improve performance. Likewise, the invention may be used in manufacturing, commercial, professional and other work environments to monitor employee activities and present recommendations for improvement of the individual and the process.

As used herein, the term “course term” refers to a period of time in which an online group learning course is conducted. A course term may be delimited by a start time/date and an end time/date. For example, and without limitation, a course term may include a course module, an academic quarter, an academic year of study, etc.). Each course term may include multiple course sessions during which an instructor and students logon to the system to conduct an online class.

Exemplary System Architecture

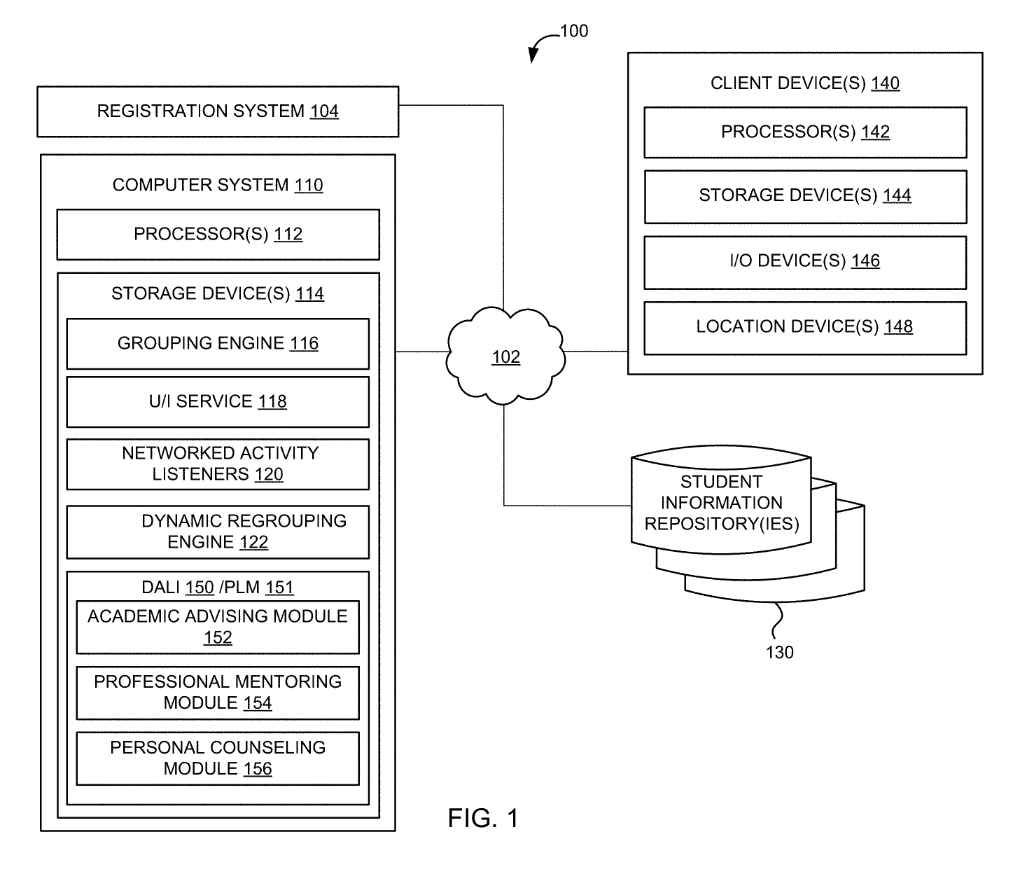

FIG. 1 illustrates a system 100 for monitoring and aggregating, via a network, performance information that indicates scholastic achievement and electronic communications of students participating in an online group learning course, conducted electronically via the network during a course term, in which the students are grouped, and potentially regrouped, based on the aggregated performance information, according to an implementation of the invention. System 100 may include, without limitation, a registration system 104, a computer system 110, student information repositories 130, client devices 140, and/or other components.

Registration system 104 may be configured to display course listings, requirements, and/or other course-related information. Registration system 104 may receive registrations of students to courses, including online group learning courses described herein. Upon receipt of a registration, registration system 104 may register a student to take a course. During the registration process, registration system 104 may obtain student information such as, without limitation, demographic information, gender information, academic records (e.g., grades, etc.), profession information, personal information (e.g., interests/hobbies, favorite cities, vacation spots, languages spoken, etc.), and/or other information about the student. Such student information may be stored in a student information repository 130.

Computer system 110 may be configured as a server (e.g., having one or more server blades, processors, etc.), a desktop computer, a laptop computer, a smartphone, a tablet computing device, and/or other device that is programmed to perform the functions of the computer system as described herein.

Computer system 110 may include one or more processors 112 (also interchangeably referred to herein as processors 112, processor(s) 112, or processor 112 for convenience), one or more storage devices 114, and/or other components. The one or more storage devices 114 may store various instructions that program processors 112. The various instructions may include, without limitation, grouping engine 116, User Interface (“UI”) services 118, networked activity listeners 120 (hereinafter also referred to as “listeners 120” for convenience), a dynamic regrouping engine 212, and/or other instructions. As used herein, for convenience, the various instructions will be described as performing an operation, when, in fact, the various instructions program the processors 112 (and therefore computer system 110) to perform the operation. It should be noted that these instructions may be implemented as hardware (e.g., include embedded hardware systems).

In addition, and particularly in relation to the DALI system and recommendation processes of the present invention, . . . .

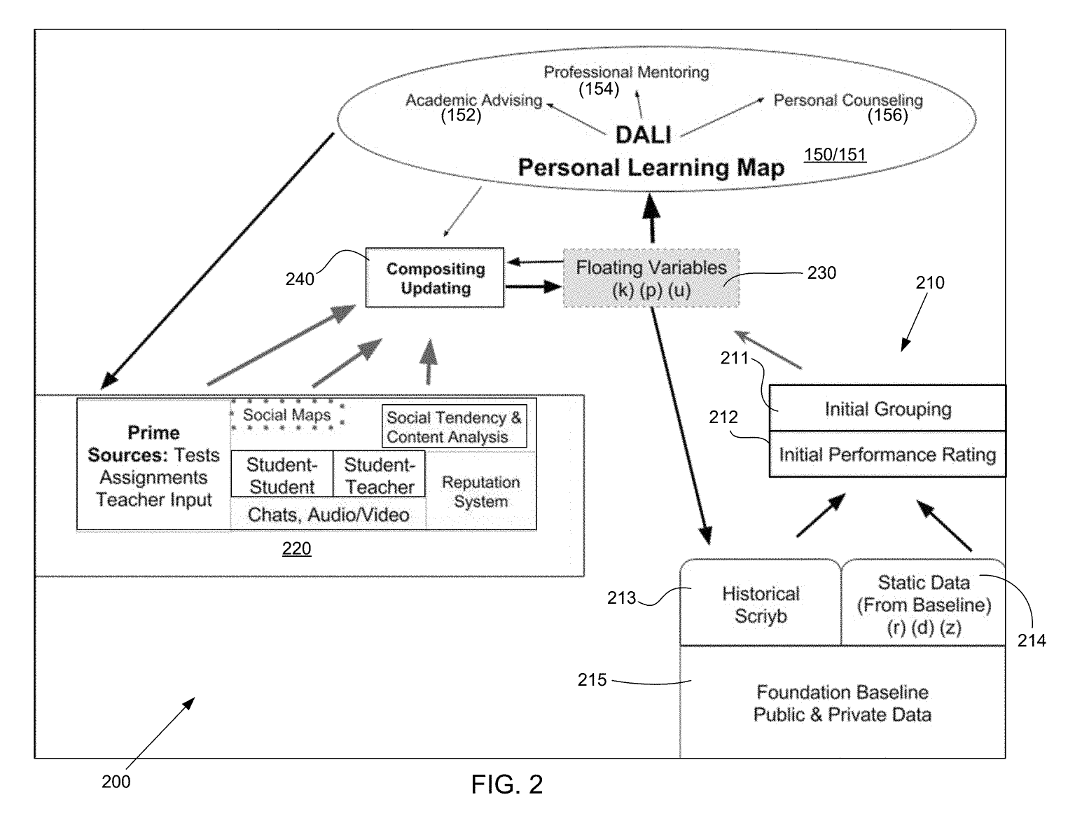

FIG. 2 illustrates a process 200 of the DALI system for monitoring and aggregating, via a network, performance information that indicates scholastic achievement and electronic communications of students participating in an online group learning course, conducted electronically via the network during a course term, and for presenting suggestions and/or recommendation to students (or any users of the system). Recommendations and suggestions are generated based on applying rules-based process to aggregated student data, including academic performance history, subject-based and non-subject based communication content understanding, and social and interpersonal behaviors.

In FIG. 2, exemplary education services and support system 200 includes DALI/PLM (150/152) system operating with an online course student grouping/assigning process 210, student and course data collection process 220, student regrouping functionality (optional) 230, and compositing/updating process 240. The DALI 150 includes Academic Advising process 152, Professional Mentoring process 154 and Personal Counseling process 156.

The system of FIG. 2 illustrates a data flow diagram of a Networked Activity Monitoring Via Electronic Tools in an Online Group Learning Course and Regrouping Students During the Course Based on The Monitored Activity (as disclosed in the '997 application) “big data” collection loop integrated with DALI to develop a student personal learning map and subsequent academic advising, professional mentoring, and personal counseling output.

The DALI system uses a Personal Learning Map as a collection of data sets associated with individual users, such as students. The DALI “learns” about each student's evolving internal (academic) and external conditions, short-term and long-term academic/professional, and personal expectations over time and such data is stored as historical and current data sets as discussed in detail below. These data sets are dynamically stored/created by DALI in each student's Personal Learning Map, and include academic performance (gathered: current and historical), external non-academic-related extenuating circumstantial factors (shared by student captured: current and historical), and behavioral (social) analysis (shared by student captured: current and historical). These four data sets can be assigned variables as can be seen below as an example of a single student's Personal Learning Map Variables and Sub-Variables:
Bₛ=Academic Performance data set current (term);
B_{f}=Academic Performance data sets historical:

$$Data set 1 \text{:} {B}_{{f}_{1} …} ∋ ( Curr . Term ) \frac{32 credits}{t} , \frac{12 courses}{t} , \frac{Major}{t} , \frac{School}{t}$$

$$Data set 2 \text{:} {B}_{{f}_{2} …} ∋ ( Hist . ) \frac{128 credits}{t} , \frac{56 courses}{t} , \frac{School}{t} , \frac{Diploma}{t}$$

Tₛ=Communication Subject data set current (term);
T_{f}=Communication Subject data sets historical:

$$Data set 1 \text{:} {T}_{{f}_{1} …} ∋ ( Curr . Term ) \frac{32 credits}{t} , \frac{12 courses}{t} , \frac{Major}{t} , \frac{School}{t}$$

$$Data set 2 \text{:} {T}_{{f}_{2} …} ∋ ( Hist . ) \frac{128 credits}{t} , \frac{56 courses}{t} , \frac{School}{t} , \frac{Diploma}{t}$$

Tₕ=Communication Non-Subject data set current (term);
Tₒ=Communication Non-Subject data set historical:

$$Data set 1 \text{:} {T}_{{h}_{1} …} ∋ ( Curr . Term ) \frac{32 credits}{t} , \frac{12 courses}{t} , \frac{Major}{t} , \frac{School}{t}$$

$$Data set 2 \text{:} {T}_{{o}_{2} …} ∋ ( Hist . ) \frac{128 credits}{t} , \frac{56 courses}{t} , \frac{School}{t} , \frac{Diploma}{t}$$

Sₑ=Social and (Interpersonal) Behavioral Traits data set current (term);
S_{q}=Social and (Interpersonal) Behavioral Traits data set historical:

$$Data set 1 \text{:} {S}_{{e}_{1} …} ∋ ( Curr . Term ) \frac{32 credits}{t} , \frac{12 courses}{t} , \frac{Major}{t} , \frac{School}{t}$$

$$Data set 2 \text{:} {S}_{{q}_{2} …} ∋ ( Hist . ) \frac{128 credits}{t} , \frac{56 courses}{t} , \frac{School}{t} , \frac{Diploma}{t}$$

Data set n: . . . .

Academic data sets are derived from graded exams, quizzes, workbooks, group projects, portfolios and other traditional methods of determining subject matter competencies, and stored in a fixed grid database. Communication data sets are derived from the syntactic analysis (parsing) using natural language/neural language model, conforming to the rules of formal, informal, and slang grammar used between the student and other students, and/or the student and instructor(s), captured via chat, texts, or forums windows within a computer based software platform.

The neural language model used by DALI is able to recognize several words in a category of category of category of words within a particular data set may be similar in structure, but they can still be encoded separately from each other. Statistically, neural language models share strength between one word, or group of words and their context, with other similar group of words and their structured context. The neural language model ‘learns’ that each word, or series of word representation (distributed) is embedded to treat words that have aspects, components, and meaning similarly in common. Words that may appear with similar features, and thereby treated with similar meaning, are then considered neighbor words, and can then be semantically mapped accordingly.

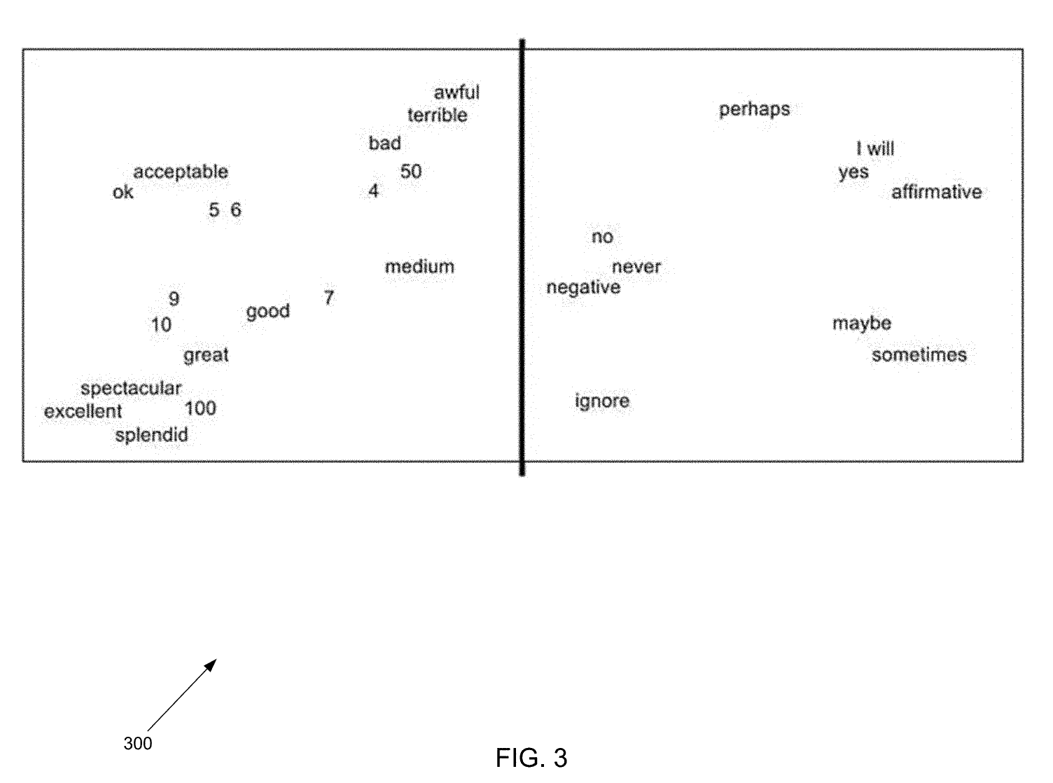

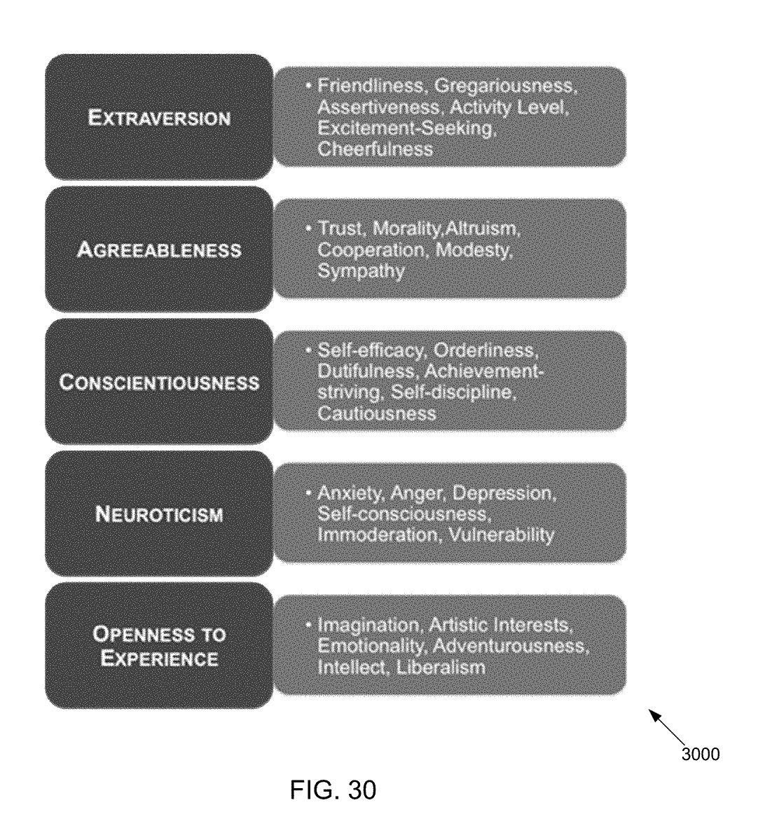

Now with reference to FIG. 3, an example of a simplified distributed representation map 300 is shown. Social and Behavioral Trait data sets are derived from both syntactic analysis using natural language conforming to the rules of formal, informal, and slang grammar used between the student and other students, and the student and instructor(s), captured via chat/text, or forums windows within a computer based software platform, and/or voice audio analysis using Fast Fourier Transform Analysis combined with pattern recognition and computational learning theory relationally matrixed to a fixed grid of five primary personality traits (Digman, J. M. (1997). Higher-order factors of the Big Five. Journal of Personality and Social Psychology, 73, 1246-1256; Hofstee, W. K. B., de Raad, B., & Goldberg, L. R. (1992). Integration of the Big Five and circumplex approaches to trait structure. Journal of Personality and Social Psychology, 63, 146-163; Lewis R. Goldberg (1990). An alternative “Description of personality”: The Big-Five factor structure. Journal of Personality and Social Psychology, 59, 6, 1216-1229), sometimes known as the five factor model (FFM): Openness, Conscientiousness, Extraversion, Agreeableness, Neuroticism. Although the quadrants of the personality traits are fixed, the student that coveys the traits are not, as individual personality traits evolve through maturation and experiences. The set of traits 3000 is shown in FIG. 30. Extraversion may include traits such as friendliness, gregariousness, assertiveness, activity level, excitement-seeking, and cheerfulness. Agreeableness may include traits such as trust, morality, altruism, cooperation, modesty, and sympathy. Conscientiousness may include traits such as self-efficacy, orderliness, dutifulness, achievement-striving, self-discipline, and cautiousness. Neuroticism may include traits such as anxiety, anger, depression, self-consciousness, immoderation, and vulnerability. Openness to experience may be characterized by traits such as imagination, artistic interests, emotionality, adventurousness, intellect, and liberalism.

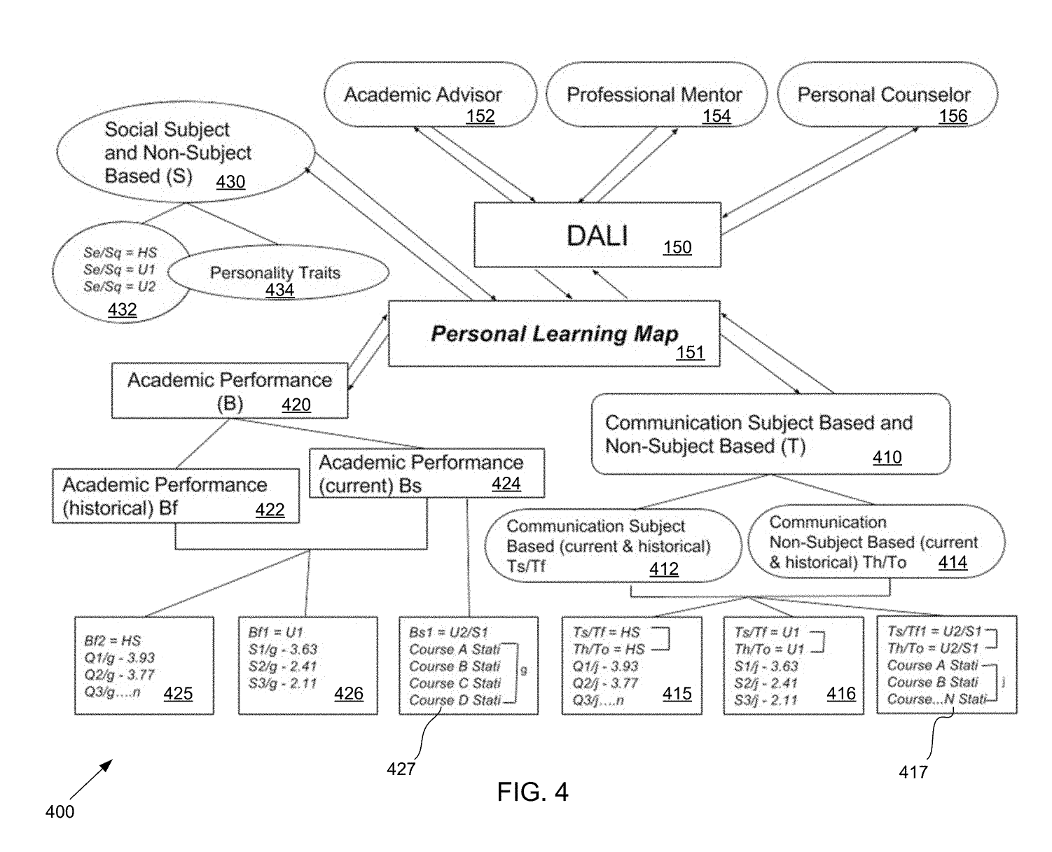

FIG. 4. demonstrates a block-flow diagram of a student's dynamic Personal Learning Map 151 created/collected by DALI 150 used to pose suggestions and recommendations during the learning process such as by functional modules: Academic Advisor 152, Professional Mentor 154 and Personal Counselor 156. Deep Academic Learning Intelligence DALI generates and presents to users, e.g., students, active and dynamic academic course corrective suggestions and recommendations, and provide umbrella (academic major or other academic pathways) academic advising. DALI will also intervene, potentially at academic or professional points of stress or conflict, to provide professional mentoring involving wisdom and advice on ways to improve their academic and/or professional pathway. This may include breaking detrimental (study) habits, adjusting demeanor, attitude, time management, communication style, interpersonal behavior, or to improve other professional traits to ensure success in the classroom and within the students' chosen professional pathway. DALI will further intervene, during the academic experience, to provide personal counseling about specific external (non-classroom) issues and events that may be negatively affecting academic performance. These issues, socially shared via a synchronous or asynchronous classroom environment with other students and/or with instructor(s), may involve personal and intimate relationships, family issues, financial pressures and concerns, legal conflicts, and other external variables that may be negatively affecting academic performance. Throughout an academic experience, both inside the classroom, but only during course breaks, prior to class time, after class, and during intersessions, DALI will provide academic advising, mentoring, and counseling suggestions and recommendations in a separate tab popup window from a computer platform. As mentioned, DALI suggestions and recommendations are based on data derived from academic performance (current and historical), communication messages directed toward other students and the class instructor (subject based or non-subject based/current and historical), and social/interpersonal demonstrated traits (current and historical). Depending on the choices made by a student: Yes I will, No Thanks, Maybe, Ignore, from the recommendations and suggestions provided, each student's personal learning map will morph and shift, allowing DALI to ‘learn’ about the ‘value’ of each suggestion and recommendation to provide better and more relevant recommendations, advice, and counsel to offer each student in the future.

In the example of FIG. 4, data received into PLM 151 includes Communication Subject Based and Non-Subject Based (t) data 410; Academic Performance (b) data 420; and Social Subject and Non-Subject Based (s) data 430. Communication Subject Based and Non-Subject Based (t) data 410 includes current (Ts) and historical (Tf) communication subject based data 412 and current (Th) and historical (To) communication non-subject based data 414, which are represented by data sets 415-417. Academic Performance (b) data 420 includes historical Bf 422 and current Bs 424 academic performance data as represented by data sets 425-427. Social Subject and Non-Subject Based (s) data 430 includes personality trait data 434 and data sets represented by 432.

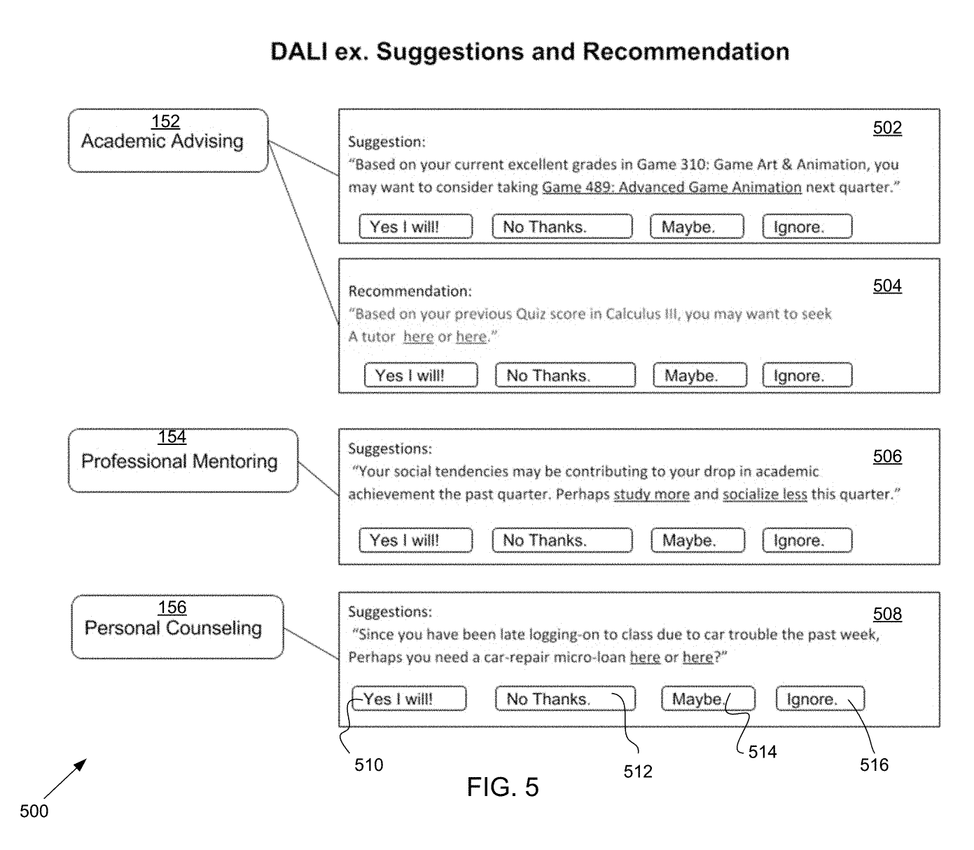

Now with reference to FIG. 5, a user interface screen 500 is shown presenting three exemplary DALI suggestions (502, 506, 508) and one exemplary DALI recommendation (504). Each recommendation and suggestion interface includes user response elements “Yes I will!” 510; “No Thanks” 512; “Maybe” 514; and “Ignore” 516. Upon a student user selecting one of the presented response elements, a signal is delivered as an input to DALI for storing, tracking and as a data point into the loop data flow for further analysis. In connection with the Academic Advising facility 152, DALI 150 presents to an individual student user a Suggestion 502 “Based on your (i.e., individual student receiving message) current excellent grades in Game 310: Game Art & Animation (i.e., online course), you may want to consider taking Game 489: Advanced Game Animation (i.e., proposed higher level course) next quarter.” The underlining represents an embedded link to enable the student to access information related to the course for further consideration and potentially registration. The determination to present the proposed course may be based on student performance in present course “Game 310” as well as student's major, stated interest, professional pathway identified, and other attributes, criteria and captured data. As in the case of “Suggestions” 506 generated by Professional Mentoring facility 154, each suggestion or recommendation may include multiple or sub-suggestions related to the same issue, e.g., “study more” and “socialize less.” In such instances, separate response elements 510-514 may be presented for each suggestion/sub-suggestion. An example of a Personal Counseling facility 156 suggestion 508 is shown in which the DALI presents a non-academic suggestion related to car repair and offering assistance in the form of a resource to obtain a “micro-loan.” Although this is on its face a non-academic related issue, to the extent unresolved issues adversely affect a student's performance, e.g., attending class, then it may be considered at least academic-related.

The suggestions or recommendations provided to a student are determined, in this exemplary manner, by logistic regression analysis, which estimates the relationship between the standing and captured input data (variables) in a student's Personal Learning Map, in order to predict a categorical outcome variable that can take on the form of a sentence or phrase.

The decision made by a student and received as input to DALI via user interface response elements 510-514: “Yes I will,” “No Thanks,” “Maybe,” and “Ignore,” are weighted and then fed back using a deep neural language network (DNLN) back propagation (Matrix×Matrix) algorithmic methodology for the (supervised) massive weight learning (training) of DALI. In this exemplary operation, the DNLN Methodology employed by DALI uses massive input variables into a deep neural language network (DNLN) to learn (train) which answers each student provides, for each use case, and the impact on their Personal Learning Map. We incorporate by reference herein in the entirety D. E. Rumelhart, G. E. Hinton, and R. J. Williams. Learning internal representations by error propagation. In D. E. Rumelhart and J. L. McClelland, editors, Parallel Distributed Processing, volume 1. MIT Press, Cambridge, Mass., 1986, which details error propagation and a scheme for implementing a gradient descent method for finding weights that minimize the sum squared of the error of a system's performance.

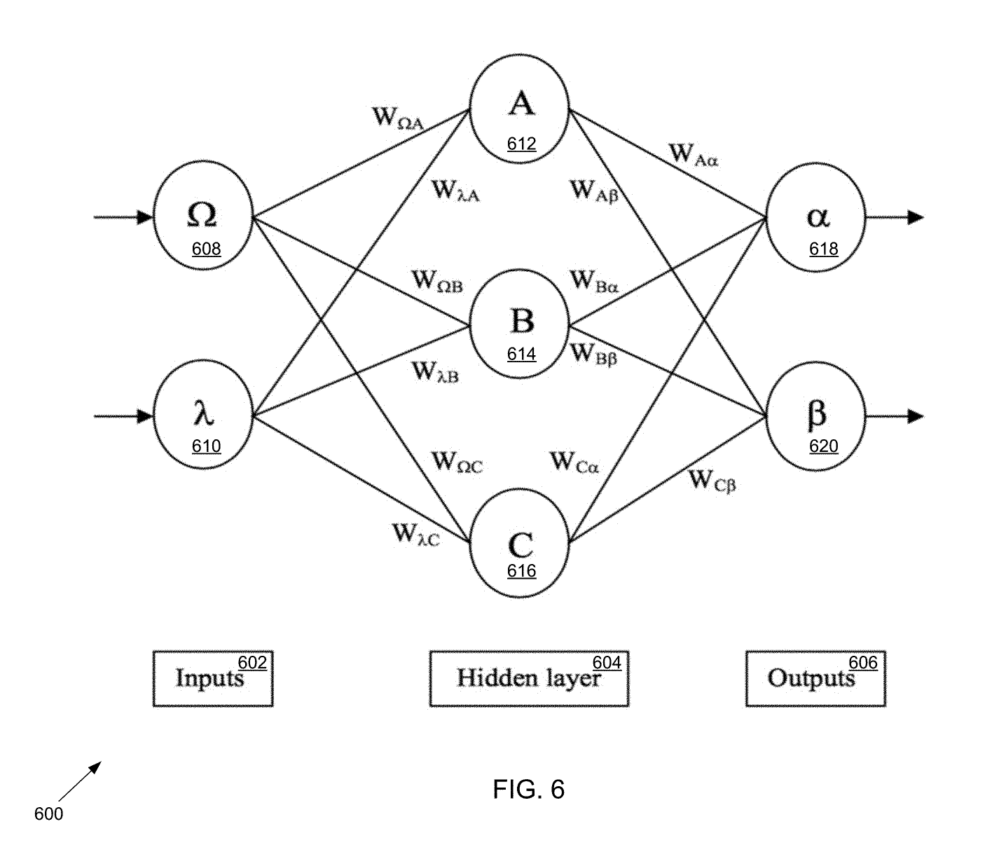

FIG. 6 illustrates a simplistic example of a typical Deep Neural Network (DNN) 600, using back propagation, having a two-variable input 602, one hidden layer 604, and two variable outputs 606 interconnected via a network defined by weighting represented by W_{x,y}. In this example, the two variable inputs are represented by Ω 608 and λ 610; the Hidden Layer 604 is represented by A 612, B 614 and C 616; and the two variable outputs are represented by α 618 and β 620. The following describes the process in detail.

To calculate the error of the outputs 606 we use:

δ_{α}=out_{α}(1−out_{α})(Target_{α}−out_{α})

δ_{β}=out_{β}(1−out_{β})(Target_{β}−out_{β})

To change the output layer weights we use:

W⁺_{Aα}=W_{Aα}+ηδ_{α}out_{A} W⁺_{Aβ}=W_{Aβ}+ηδ_{β}out_{A}

W⁺_{Bα}=W_{Bα}+ηδ_{α}out_{B} W⁺_{Bβ}=W_{Bβ}+ηδ_{β}out_{B}

W⁺_{Cα}=W_{Cα}+ηδ_{α}out_{C} W⁺_{Cβ}=W_{Cβ}+ηδ_{β}out_{C}

These weights effect the accuracy of the suggestion or recommendation provided to a student, and impact the value of the responses provided. To calculate the hidden layer errors so the network learning (training) accuracy can improve we use:

δ_{A}=out_{A}(1−out_{A})(δ_{α}W_{Aα}+δ_{β}W_{Aβ})

δ_{B}=out_{B}(1−out_{B})(δ_{α}W_{Bα}+δ_{β}W_{Bβ})

δ_{C}=out_{C}(1−out_{C})(δ_{α}W_{Cα}+δ_{β}W_{Cβ})

Finally, to change the hidden layer weights to improve response accuracy we use:

W⁺_{λA}=W_{λA}+ηδ_{A}in_{λ} W⁺_{ΩA}=W⁺_{ΩA}+ηδ_{A}in_{Ω}

W⁺_{λB}=W_{λB}+ηδ_{B}in_{λ} W⁺_{ΩB}=W⁺_{ΩB}+ηδ_{B}in_{Ω}

W⁺_{λC}=W_{λC}+ηδ_{C}in_{λ} W⁺_{ΩC}=W⁺_{ΩC}+ηδ_{C}in_{Ω}

Constant η is put into the equations to speed up (or slow down) the learning (training) rate over time. An example of a more complex DNN keeps learning until all the errors of a response fall to a pre-determined value and then loads the next response. Once the DALI network has learned the importance or insignificance of the suggestions and recommendations, the process starts over again. The simplistic example thus illustrated does not fully represent DALI's requirements to learn from the massive of amounts of student data and response data input/output. Indeed that is one of the benefits of deep neural networks is the effectiveness of the machine learning given many hidden layers. In practical use, for a typical operation DALI requires over one million hidden layers with 100 million weights to effectively learn from all the one million-plus data sets and decisions points in each student's Personal Learning Map.

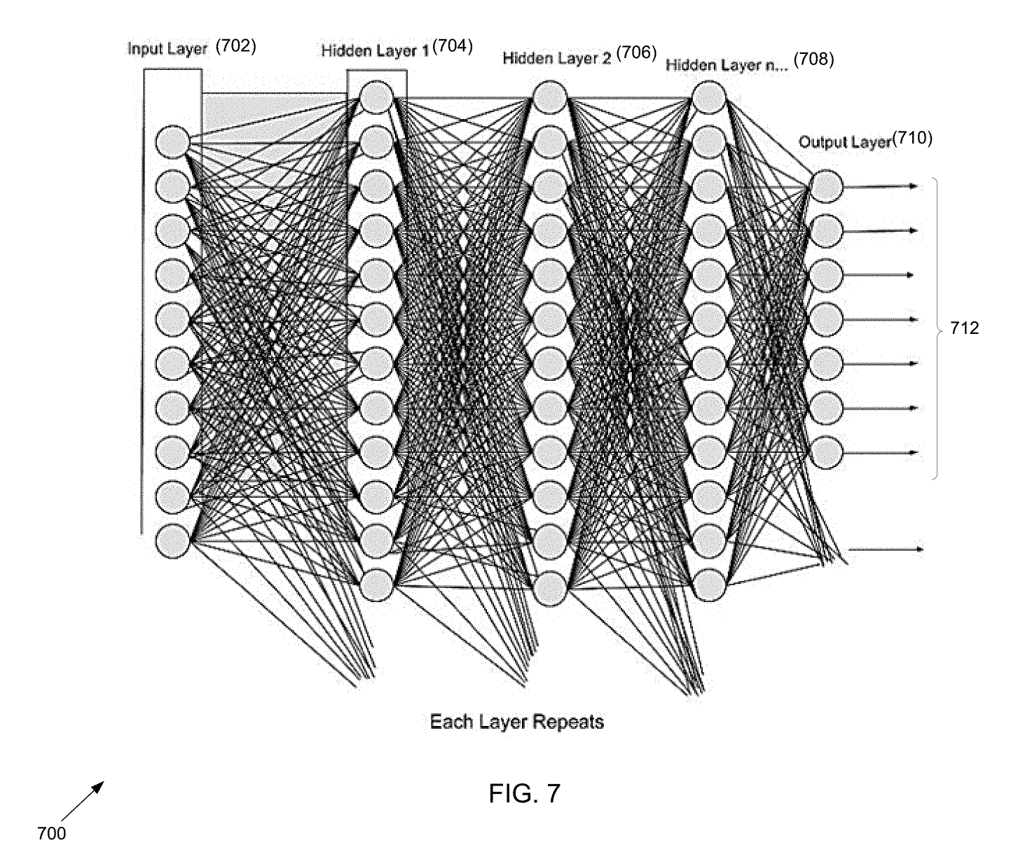

FIG. 7, provides an example of a DNN using n . . . number of imputs, with n . . . number of hidden layers and outputs. As shown in this example, DNN 700 is shown as a Matrix×Matrix (M×M) algorithmic back propagation methodology, e.g., as derived from Softmax function scores. DALI combines the machine learning methodology of a DNN Matrix×Matrix (M×M) algorithm with a neural language model, and dynamically stored current and historical student data frames the Personal Learning Map.

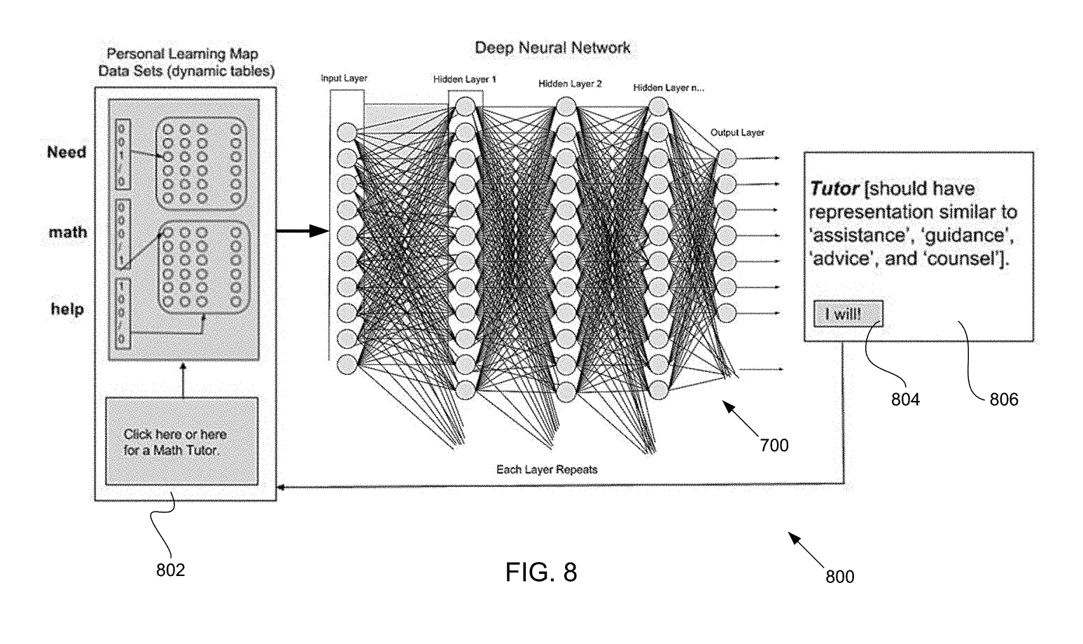

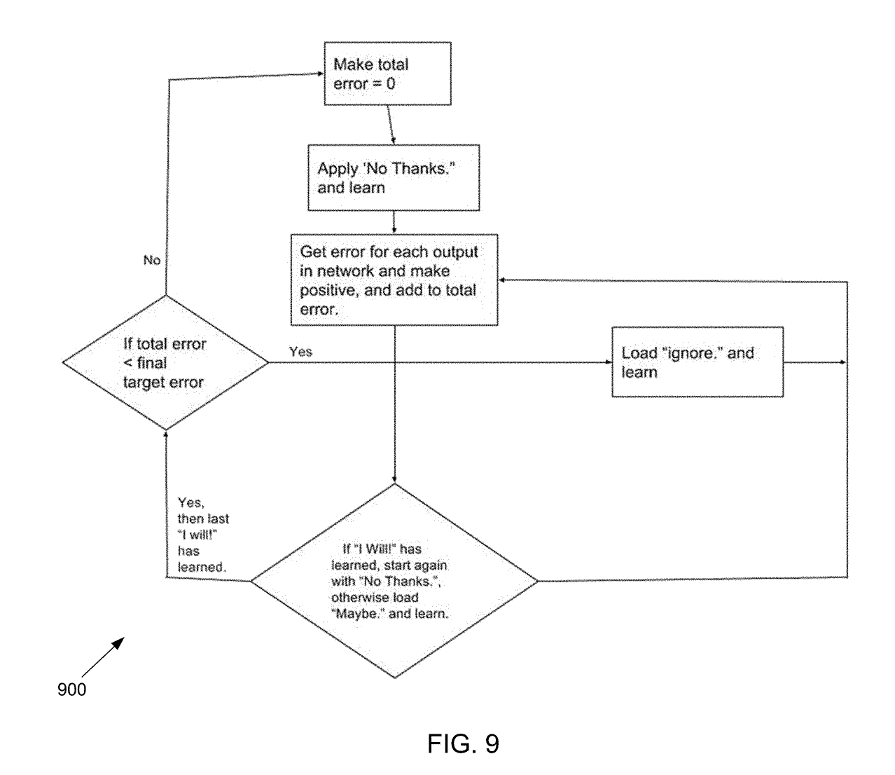

FIG. 8 illustrates a simplified example of the neural language distributed representation PLM 802 (words that may appear with similar features, and thereby treated with similar meaning, are then considered neighbor words and can be semantically mapped), as input into a multi-hidden layer DNN 700, and as output as a recommendation model 804. The system learns by way of learning feedback into PLM 802 as a signal received when the user selects user interface response element 806. In this manner the DALI system is configured as a DNLN model with PLM and Suggestion/Recommendation response loop. In addition, the suggestions or recommendations provided to a student may be determined by logistic regression analysis, which estimates the relationship between the standing and captured input data (variables) in a student's Personal Learning Map, in order to predict a categorical outcome variable that can take on the form of a sentence or phrase in recommendation model 804. The decision made by a student, e.g., via response interface elements 510-514 as shown in FIG. 5: “Yes I will,” “No Thanks,” “Maybe,” “Ignore,” are weighted and then fed back using a deep neural language network (DNLN) back propagation (Matrix×Matrix) algorithmic methodology for the (supervised) massive weight learning (training) of DALI. A simplified block-diagram example of this process is illustrated in FIG. 9.

DALI employs the Matrix×Matrix (M×M) algorithmic back propagation methodology, from Softmax function scores, that uses batching to reuse weights in error correction. Batching allows for larger memory recalls (reusing weights) so improves clock operations taking advantage of current and future computer memory management designs.

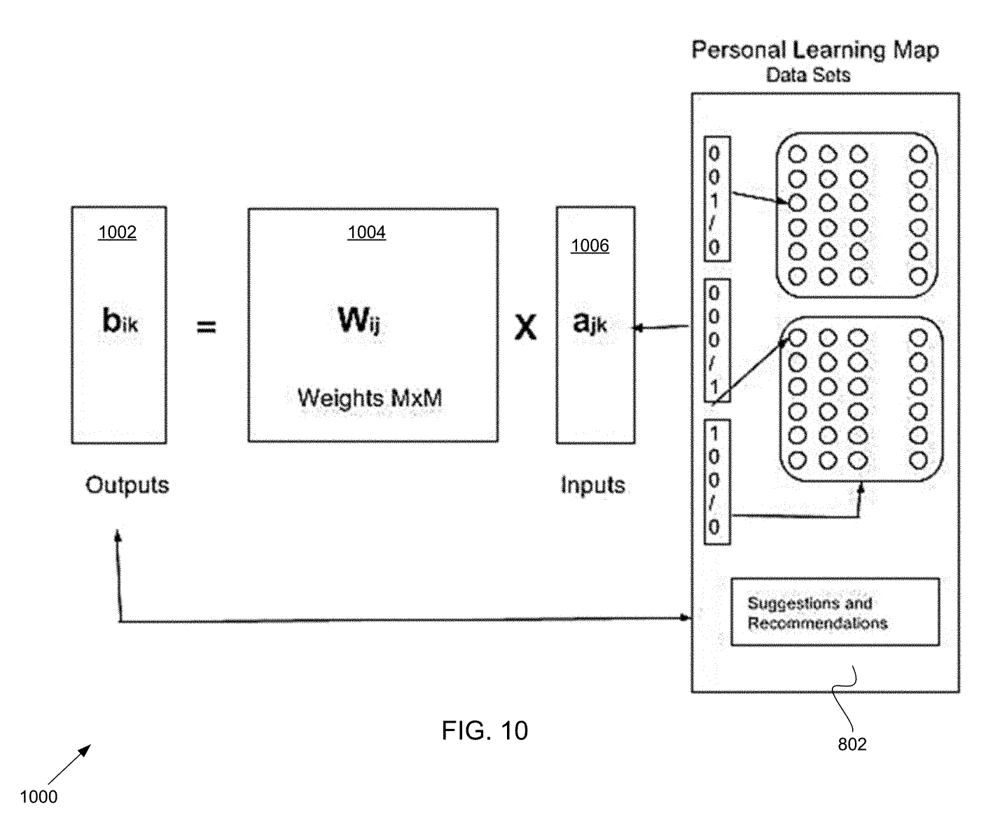

FIG. 10 illustrates a simplified block diagram of the DALI DNLN 1000 with weight update formula. The weight update formula is represented as weighted M×M matrix Wij 1004 in FIG. 10, which is a simplified version of the DNN matrix illustrated in FIG. 8.

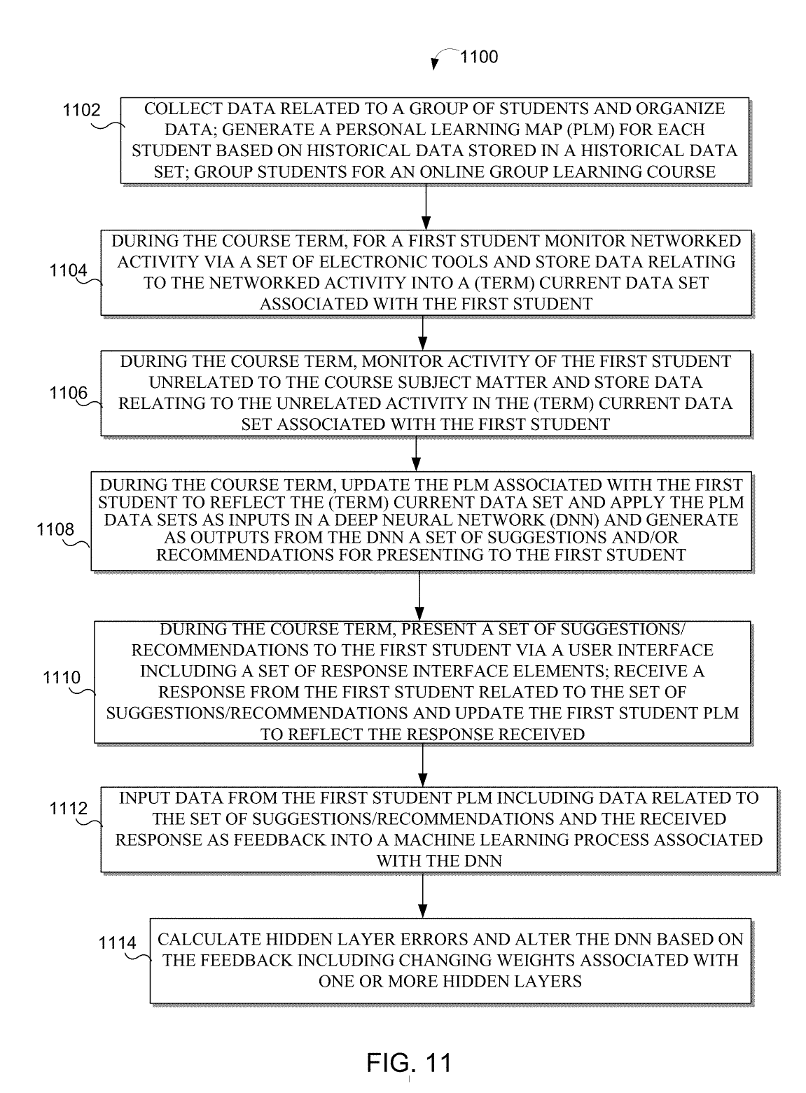

FIG. 11 illustrates an exemplary flow of the processes associated with the DALI operation over the term of an online course.

DALI's intelligence is configured with the assumption that a user's complete well-being and success depends on their educational success (and continuing education, training, and retraining for a lifetime) and is their primary focus: and, therefore, necessarily has a negative or positive influence on all other aspects of their life. DALI represents an evolution in virtual machine learning educational solutions to ensure academic success, and in turn, success in other life aspects for each user.

DALI elevates the educational experience for students by making active and dynamic academic course corrective suggestions and recommendations as an intelligent virtual academic advisor within and external to the classroom. DALI intervenes at academic or professional points of stress or conflict, to provide professional mentoring involving (learned) wisdom and advice on ways to improve one's academic and/or professional pathway. DALI intervenes during the academic experience to provide personal counseling about specific external (non-subject) issues and events that may be negatively affecting academic performance. These issues, socially shared may involve personal and intimate relationships, family issues, financial pressures and concerns, legal conflicts, and other external variables that may be negatively affecting academic performance. DALI transforms education by providing the (virtual) resources, guidance, and direction students require in the ever-changing and evolving subject matter of today and in so doing helps students advance and grow intellectually and academically, succeed in their chosen professional pathway, and achieve future academic advancement.

Knowledge Acquisition System and Enhanced Personal (Omega) Learning Map

In a further aspect the present invention provides a highly effective knowledge acquisition system (KAS) utilizing a new memory model to provide enhanced personal learning maps, referred to herein as personal learning map (PLM) and entity-specific learning map and “Omega” learning map (ΩLM). The KAS provides a unique approach to storing and retrieving massive learning datasets within an artificial cognitive declarative memory model. In addition, the declarative memory model may include the additional feature of an artificial Episodic Recall Promoter (ERP) module also stored in long-term and/or universal memory modules, to assist students with recall of academic subject matter as it relates to knowledge acquisition.

Although the KAS, Omega Learning Map (ΩLM) and memory model aspects of the invention are described in the context of DALI and DNLN implementation, this is for purposes of describing the operation of the invention and not by way of limitation. The KAS and memory model described herein may be used in a variety of environments. For example, and not by limitation, this new memory storage model provides improved and useful storage and retrieval of the immense student data derived from utilizing multiple interleaved machine-learning artificial intelligence models to parse, tag, and index academic, communication, and social student data cohorts as applied to academic achievement, that is available to capture in an Aggregate Student Learning (ASL) environment. Also, although often described as Omega Learning Map (ΩLM), this feature is also described in terms of (enhanced) Personal Leaning Map (PLM) and entity-specific learning map, the terms as used herein are interchangeable with common scope and meaning and particular use does not limit the scope of the invention. As referenced hereinbelow, the PLM is an enhanced version of the PLM described hereinabove.

We now describe the invention in the context of one exemplary implementation of the KAS and PLM and memory models in connection with DALI and in the ASL environment. The KAS and related Omega Learning Map (ΩLM) and memory models write and retrieve (store and access) student learning datasets available from Aggregate Student Learning (the collection and consideration of academic and non-academic communication and social data together) associated with Deep Academic Learning Intelligence (DALI) System and Interfaces. DALI's DNLN AI models parses these immense datasets utilizing artificial cognitive memory models that includes Working Memory (buffer) and a Short-Term Memory (STM) model that includes a unique machine learning (ML) trained entropy function to decipher, identify, tag, index, and store subject (academic) and non-subject communication and social data. Moreover, DALI stores relevant, important, and critical singular earning and learning and social cohort datasets in the appropriate ΩLM Declarative Memory (Sub-Modules) for later retrieval. Further, the ΩLM stored datasets, singular and (integrated) cohorts, provide DALI the sources for dynamic regrouping of students into a more conducive academic environment, corrective academic and social suggestions and recommendations, as well as episodic memory information for the academic context recall assistance ERP apparatus.

Datasets include academic performance history, subject-based and non-subject based communication content understanding, and social and interpersonal behavioral analysis. Over time, DALI will “learn” (be trained) about each student's evolving external environment, condition, state, and situation (non-subject matter) as they impact, or may impact (intrusive) student academic performance within an online learning platform. Upon detecting a potential issue, shared through a communication channel with an instructor or another student or students in their same grouped class and course, DALI will make appropriate corrective suggestions and recommendations to the student to remediate and modify potential negative outcomes. The student trains their DALI DNLN ML model by responding in kind if the recommendation or suggestion was followed, and by the responses received, e.g., if the suggestion or recommendation was helpful. The student's initial response options, from the recommendation or suggestions, are generally limited to Yes I will, No Thanks, Maybe, Ignore, but the helpful solicitation allows DALI to receive an even greater entropy vector to offer more accurate and impactful recommendations and suggestions to students in the future. Within an online learning platform, every student's initial grouping data, dynamic regrouping, and every DALI recommendation and suggestion and related responses, and ERP recall and results are stored in each student's personal ΩLM.

Based on the data stored within a student's personal Omega Learning Map, DALI will make active (intrusive) and dynamic academic course corrective suggestions and recommendations, and provide umbrella (course, term, major or other academic pathways) academic advising. DALI will also intervene, potentially at professional, academic, or personal points of stress or conflict, to provide individual mentoring involving advice and suggestions about ways to improve a student's academic and professional pathway. This may include breaking detrimental study habits, adjusting demeanor, attitude, time management, communication style, interpersonal behavior, improving other professional traits to ensure success in the classroom and within the student's chosen professional pathway. DALI will further intervene, during an academic experience, to provide personal counseling about specific external (non-subject) issues and events that may be negatively affecting academic performance. The student's external condition, state, and situation, freely shared socially with other students and with instructor(s), may involve personal and intimate relationships, family issues, financial pressures and concerns, legal conflicts, and other potentially disruptive external conditions that may be negatively affecting academic performance.

Depending on the reply and “helpful” responses made by a student as a result of the recommendations and suggestions provided by DALI, and the resultant academic performance improvement or decline, each student's personal Omega Learning Map will adapt and evolve, allowing DALI to learn more about the value of each suggestion and recommendation to better provide more relevant recommendations, advice, and counsel for each student in the future.

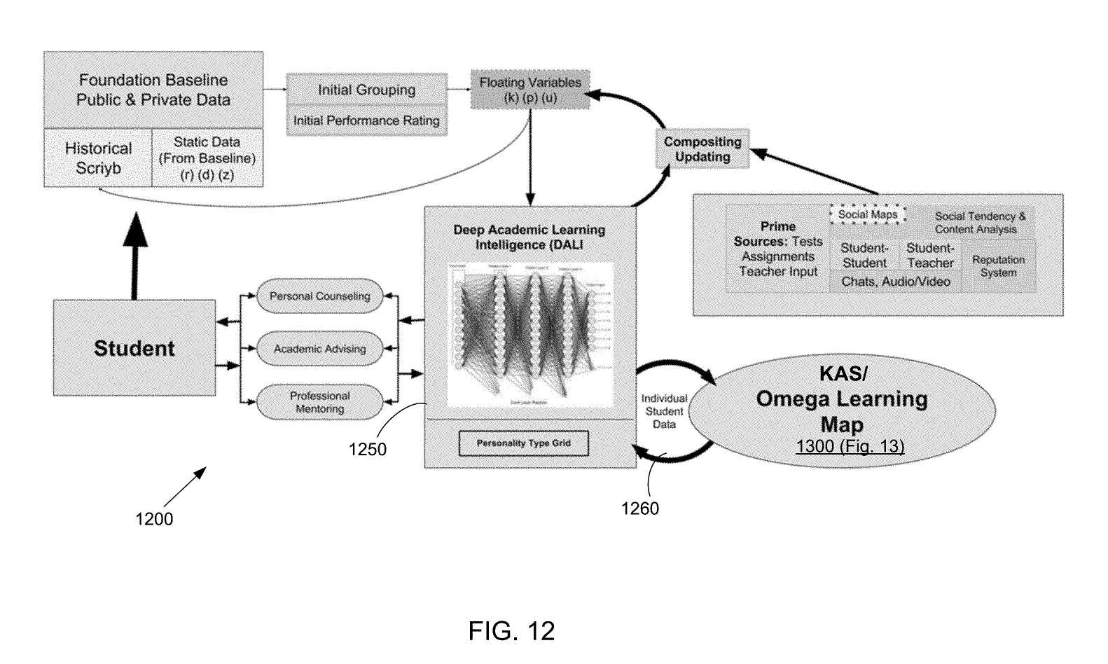

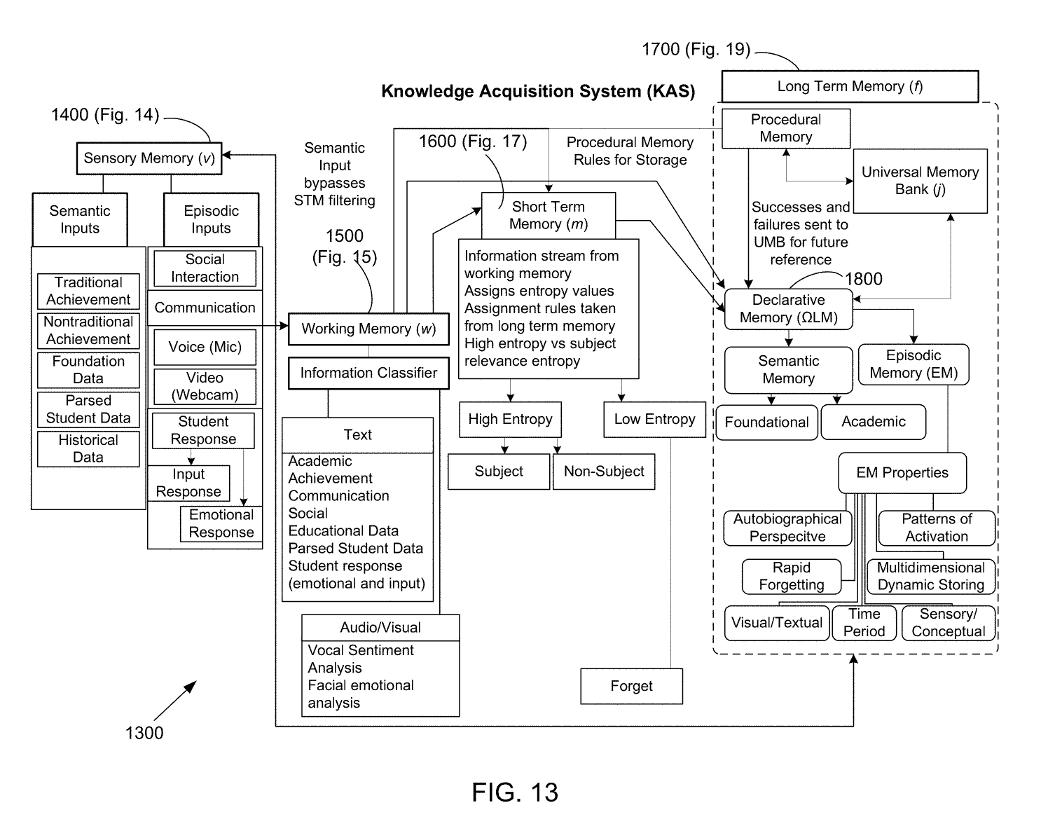

FIG. 12 is a schematic diagram of an online learning platform and dataflow 1200 including DALI 1250 integrated and connected with the KAS/Omega Learning Map facility 1300 (described in detail below and as shown at FIG. 13), and subsequent data collection and distribution loop including an initial student grouping methodology. We refer to the teachings of the '997 application and the '579 application both incorporated by reference above. FIG. 12 also demonstrates the dataflow of the academic advising, professional mentoring, and personal counseling input and response process throughout an academic journey.

The deep neural language network (DNLN) models used by DALI are adapted to recognize several words in a category of category (of category) of words within a particular data set that may be similar in structure, but they can still be encoded separately from each other (Bengio et al, 2003). Statistically, neural language models share strength between one word, or group of words and their context, with other similar group of words and their structured context. The neural language model can be trained so that each word, or series of word representations (distributed) is embedded to treat words that have aspects, components, and meaning similarly in common. Words that may appear with similar features, and thereby treated with similar meaning, are then considered “adjoining words”, and can then be semantically mapped accordingly. DALI is trained from the external and internal student conditions, situations, states, and activity variables and sub-variables and creates an Omega Learning Map for each student.

Aggregate Student Learning

Aggregate Student Learning (ASL) as used herein refers to a contemporary revision to the definition of “Whole Student Learning”, which is widely understood in post-secondary education to be an expansion of the classroom and lab academic experience to include integrated activities and support from the offices of Student Affairs, Student Counseling, and Student Life in the overall learning plan of a student. ASL encompasses a unified consideration, analysis, and assessment of academic subject data and non-subject socially shared data points in measuring student achievement within a student's overall academic rubric. ASL implies the consideration, analysis, and assessment of data gathered virtually and freely shared by student(s) within a digital learning platform. In addition, ASL may include additional data points derived from virtually considered student support services such as academic advising, professional mentoring, and even student counseling, whether provided by a live-streamed professional, or via machine-learning artificial intelligent algorithms.

Knowledge Acquisition System and Memory Model

FIG. 13 depicts a schematic diagram illustrating an exemplary embodiment of a complete Knowledge Acquisition System Model (KAS) and associated memory model (collectively referenced as 1300). The KAS 1300 is an expanded and refined version of the original after-image, primary, and secondary memory model first proposed by William James in 1890 (James, W. (1890). The principles of psychology. New York: H. Holt and Company). As shown in FIG. 13, KAS 1300 comprises Sensory Memory Module 1400, Working Memory Module 1500, Short-Term Memory Module 1600, Long-Term Memory Module 1700, and Declarative Memory Module 1800. Optional memory components Procedural Memory and Universal Memory Bank are also shown.

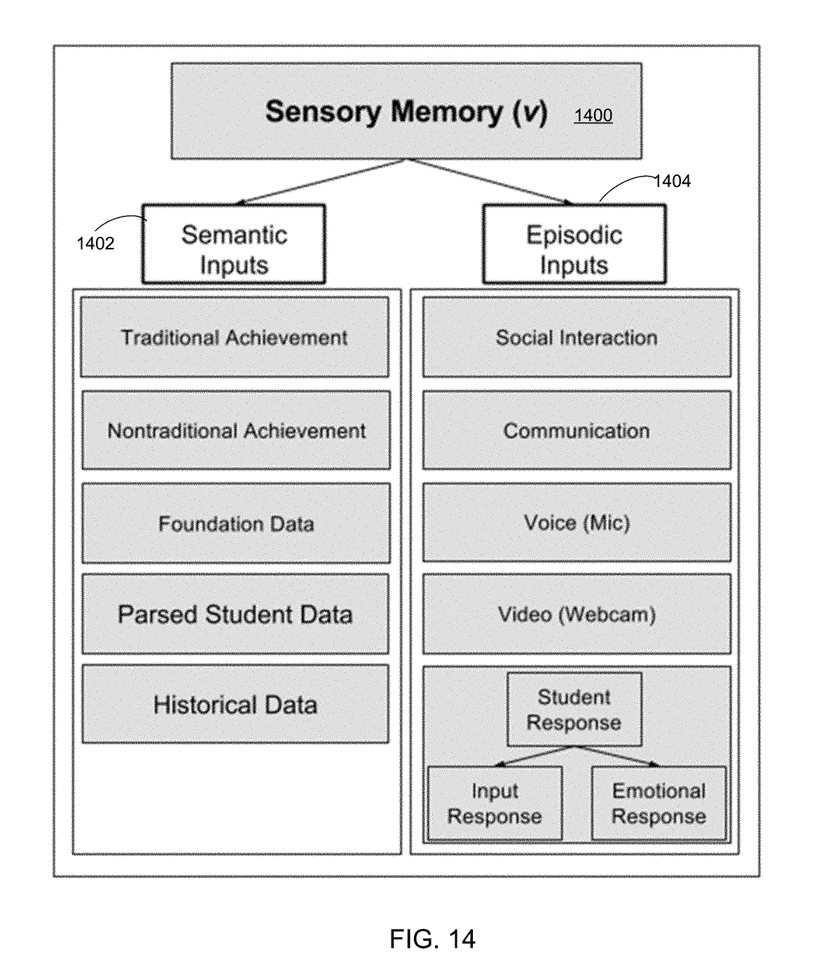

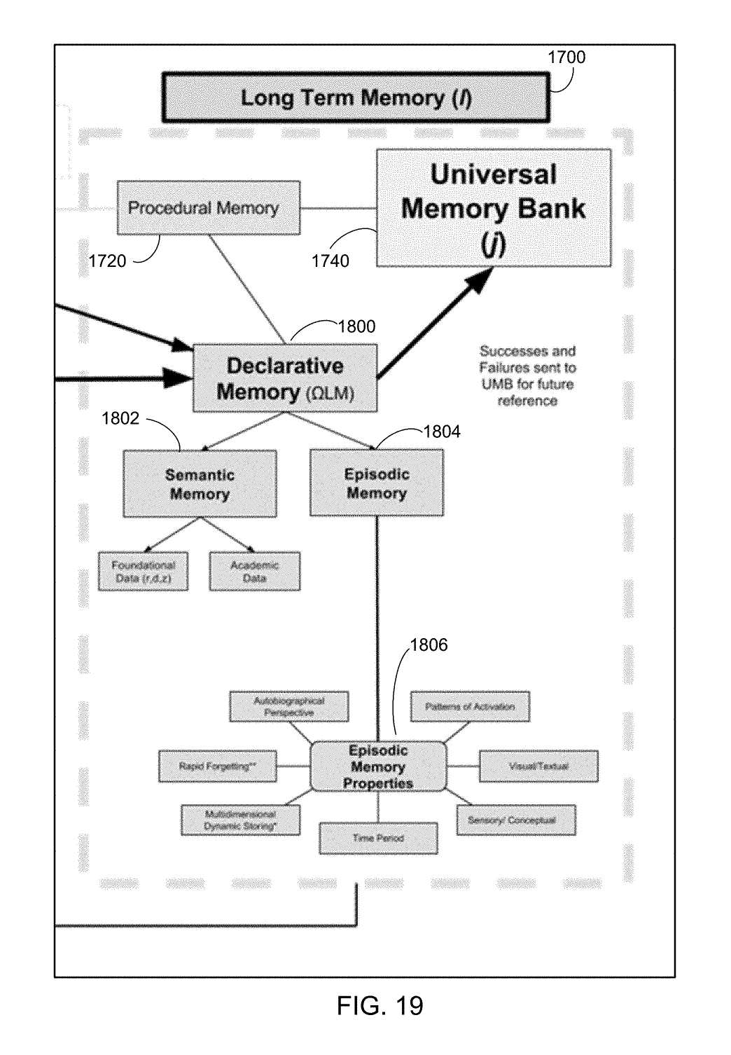

The inventors transpose James's after-image memory model into a Sensory Memory Module 1400 that contains both current and historical learner's data defined as Semantic Inputs 1402 (FIG. 14), and the channels (text, spoken, visual) of the learner's experiences around the acquisition of the Semantic Inputs, as Episodic Inputs 1404 (FIG. 14). The inventors also divide James's primary memory model into Working Memory Module 1500 and Short-Terms Memory Module 1600. Further, James's secondary model in the present invention is represented as a unique Long-Term Memory Module 1700 that contains a learner's Declarative Memory 1800 including Sensory and Episodic Memory inputs 1802 and 1804 respectively (FIG. 19), as well as Procedural Memory Module 1720 and Universal Memory Bank 1740 (FIG. 19). These simulated cognitive software structures are adapted to correctly decipher, identify, tag, index and store all the student data provided and available within online learning platform OLP 1200, and to retrieve and transmit the data back to the learner within the context of a relevant academic experience.

With reference to FIG. 13, the Knowledge Acquisition System (KAS) provides a unique social science and mathematical construct to decipher, store, and transfer (read and write) Aggregate Student Learning (ASL) DALI (DNLN) parsed, tagged and indexed data that ultimately creates and informs a student's personal Omega Learning Map. As described by Newell, “knowledge’ is technically something that is ascribed to an agent by an observer (Newell, A. (1990). The William James lectures, 1987. Unified theories of cognition). Knowledge within KAS includes information required to make recommendations or suggestions. To accurately record and store this information for every student, a detailed and organized data recognition and storage process must be implemented. The goal of the KAS is to perform this recognition and storage function, and to mimic the various memory systems of the human pre-frontal and hippocampus. The separation of the memory process into several independent and parallel memory modules is required as these separate memory systems serve separate and incompatible purposes (Squire, L. R. (2004). Memory systems of the brain: a brief history and current perspective. Neurobiology of learning and memory, 82(3), 171-177). The KAS is divided into four prime variable groups, each representative of a human hippocampus model including Sensory Memory (v), Working Memory (w), Short Term Memory (m), Long Term Memory (l). Another unique feature of the KAS invention is the Universal Memory Bank (j) (UMB). The UMB tags and indexes student parsed data from an integrated cohort vector experience, which is the sum of the DALI suggestions and recommendations responses, and the follow-up Helpful responses that may represent potential universal conditions that another student may experience in the future. DALI also stores the sum of each tagged cohort vector experience, whether successful, or the suggestions and Helpful solicitation was a failure, outside any student's ΩLM, decoupled from any student's silhouette within a generic Long-Term Memory (LTM) schemata. If a tagged cohort vector experience is recognized as similar (parsed, tagged, and indexed) by DALI as another student's conditional experience, she will only provide previously successful recommendation and suggestions to help ameliorate the issue or conflict, thereby using other student's data to solve a different student's similar issue.

The KAS mimics human brain functions in the prefrontal cortex and hippocampus, where short-term and long-term memories are stored (Kesner, R. P., & Rogers, J. (2004). An analysis of independence and interactions of brain substrates that subserve multiple attributes, memory systems, and underlying processes. Neurobiology of learning and memory, 82(3), 199-215). The KAS 1300 integrates with DALI 1250 to create and inform each student's Omega Learning Map. The system continually compiles and updates data for every student enrolled in the online learning platform, from the initial compilation of the Student Silhouette using initial grouping algorithms, to the end of the student's enrollment in an educational experience.

Sensory Memory (v) Module

FIG. 14 is a schematic diagram illustrating an exemplary Sensory Memory Module (v) 1400 in the Knowledge Acquisition System (KAS). Within the human memory system as outlined above, Sensory Memory is defined as the ability to retain neuropsychological impressions of sensory information after the offset of the initial stimuli (Coltheart, M. (1980). Iconic memory and visible persistence. Perception & Psychophysics, 27(3), 183-228. https://doi.org/10.3758/BF03204258). Sensory Memory of the different modalities (auditory, olfaction, visual, somatosensory, and taste) all possess individual memory representations (Kesner, 2004). Sensory Memory 1400 includes both sensory storage and perceptual memory. Sensory storage accounts for the initial maintenance of detected stimuli, and perceptual memory is the outcome of the processing of the sensory storage (Massaro, D. W., & Loftus, G. R. (1996). Sensory and perceptual storage. Memory, 1996, 68-96). In the context of the KAS 1300, the Sensory Memory Module 1400 also serves to recognize stimuli. Initially, all memory is first perceived and stored as sensory inputs derived from various sources.

In accordance with the DALI integration with KAS/PLM invention, sensory inputs include, but are not limited to: academic achievement/performance (gathered or provided: current and historical); internal academic-related communications factors (shared by student and teacher, current and historical); external non-academic-related extenuating circumstantial factors (shared by student, current and historical); behavioral (social) analysis (current and historical).

These Sensory Memory inputs are divided into two categories, referred to as Semantic Inputs 1402, and Episodic Inputs 1404. Semantic inputs 1402 comprise all data regarding general information about the student, such as Traditional Achievement, Non-Traditional Achievement, Foundational Data, Parsed Student Subject and Non-Subject Communication channel data, and Historical Data from an online learning platform OLP educational experience. Episodic inputs 1404 comprise all data regarding an individual's personal event experiences, such as information parsed, tagged, and indexed from the communication channels, from the instructor-students and student-instructor, as well as social subject and non-subject chats/texts and Audio/Visual channels. These inputs 1402 and 1404 are collected through various machine “senses” such as the chat-logs, microphone, webcam (speech-to-text and facial recognition), and any specific data fields used by a student and mined through machine-learning Natural Language Analysis and Processing NPL (e.g., parsing). FIG. 14 outlines a block diagram of the Sensory Memory Module 1400 in the KAS 1300 data storage and retrieval system.

Working Memory (w) Module

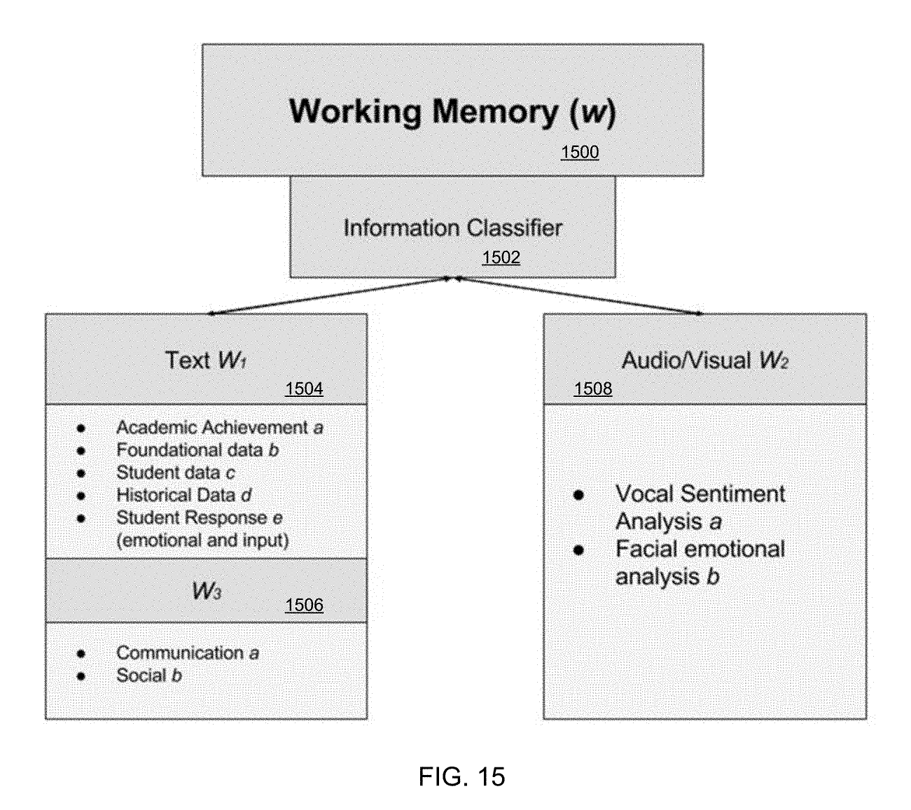

FIG. 15 is a schematic diagram illustrating an exemplary Working Memory Module 1500 of the KAS 1300. The working memory in the human frontal cortex serves as a limited storage system for temporary recall and manipulation of information, defined as less than <30 s. Working Memory 1500 (sensory buffer memory) is represented in the Baddeley and Hitch model as the storage of a limited amount of information within two neural loops, comprised of the phonological loop for verbal material, and the visuospatial sketchpad for visuospatial material (Baddeley, A. D., & Hitch, G. (1974). Working memory. Psychology of learning and motivation, 8, 47-89). In addition, the Working Memory (sensory buffer memory) 1500 can be described an input-oriented temporary memory corresponding to the five sensors of the brain known as vision, audition, smell, tactility, and taste The Working Memory 1500 stored content can only last for a short time frame (<30 s) until new data arrives to take the place of the previous data. When new data arrives, the old data in the queue should either be moved into Short-Term Memory 1600 or be forgotten and replaced by the new data. FIG. 15 outlines the KAS Working Memory Module 1500.

Let Wj=the probability that a dataset in W1 is lost when a new dataset arrives in W2, (or the inversion). Therefore, W1+W2+W3+Wn . . . =1, since every time a new dataset enters the working memory module within >30 s timeframe (buffer), the previous dataset is pushed to the Short-Term Memory Module 1600 or transferred directly to the Long-Term Memory (LTM) module 1700 or forgotten. Within the Working Memory Module 1500 more complex functions than mere temporary storage are enacted within a processing component referred to as the central executive. The central executive is responsible for actions such as the direction of information flow, the storage and retrieval of information, and the control of actions (Gathercole, S. E. (1999). Cognitive approaches to the development of short-term memory. Trends in cognitive sciences, 3(11), 410-419). Engle, Tuholski, Laughlin, & Conway (Engle, R. W., Tuholski, S. W., Laughlin, J. E., & Conway, A. R. (1999). Working memory, short-term memory, and general fluid intelligence: a latent-variable approach. Journal of experimental psychology: General, 128(3), 309) further described it as an “attention-management” unit that assigns weights and computational resources for multiple tasks management depending on their level of complexity to maintain continuous operation. The Working Memory Module 1500 within the KAS 1300 is based upon this model with necessary modifications as relevant to the online student learning experience. All inputs 1402,1404 from the Sensory Memory 1400 are sent to the Working Memory Module 1500, which, in the Knowledge Acquisition System 1300, performs as temporary storage and as an Information Classifier.

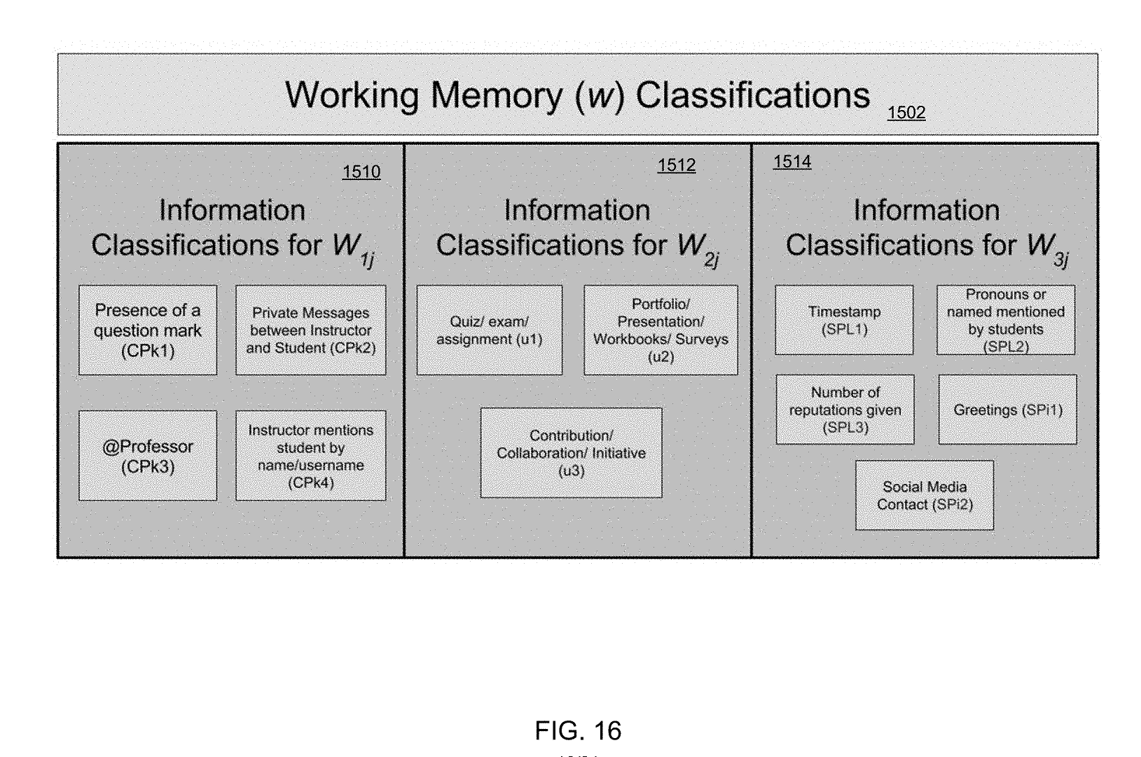

FIG. 16 is a schematic diagram illustrating an exemplary Information Classifier(s) 1502 for W for use in the Working Memory Module 1500. This Information Classifier 1502 functions is analogous to the central executive described by Baddeley and Hitch (1974), as it directs information through the Working Memory system's information classification loops, which correspond to neural loops, and thus retrieves and directs the classified information to its next respective destination as seen in FIG. 16. Utilizing Natural Language Analysis and Processing (NPL) data from DALI 1250, the Working Memory 1500 identified the input as W1 or W2 and then channels the tagged, timestamped, and indexed data with relevant identifiers appropriately. In addition, all the various data types and forms are packaged and translated in a uniform computer language to facilitate future functions and calculations on the data in both the STM 1600 and LTM 1700 Modules.

The Information Classifier 1502 in the Working Memory 1500 classifies using two main categories, W1 (text) 1504 and W2 (audio/visual) 1508, and determines if the parsed data can be categorized in the fields of Traditional Achievement, Communication, and Social (see FIG. 15). Mass Student informational data from both Semantic and Episodic sensory inputs 1402, 1404 pass through the Working Memory Module 1500, as data must be classified, e.g., as NLP parsing with relevant tags and indexed. However, after being classified in Working Memory, the Semantic and Episodic inputs 1402, 1404 are separated due to the nature of each type of information. All semantic information is designated as important, as Semantic inputs 1402 by nature are factual segments of information like grades or foundational data. In contrast, Episodic inputs 1404 are personal event-related information and will include some non-important information. Due to this assumption, semantic inputs 1402 are distributed directly into the artificial cognitive Declarative Memory Model 1800 of the LTM Module 1700. Episodic inputs 1404 are sent to the Short-Term Memory 1600. The LTM Module 1700 will serve as each individual student's personal ΩLM.

Let W₁₍ₜₑₓₜ₎, W_{2(audioivisual)} or W₃ represent a vector=(W₁ₐ, W_{1b}, W_{1c}, . . . , W₁ₙ) a-n representing the sub-variables representing datasets outlined in FIG. 15. Therefore, the probability to classify sub-variable datasets in W₁ is:

$$p ( {C}_{k} \vert {W}_{1} ) = \frac{p ( {C}_{k} ) p ( {W}_{1} \vert {C}_{k} )}{p ( {W}_{1} )}$$

where k is the possible outcomes of classification and C is the sub-variable group.

Utilizing logistic regression to classify and predict our sub-variables classes or datasets is:

$$log \frac{p ( {C}_{1} \vert {W}_{1} )}{p ( {C}_{2} \vert {W}_{1} )} = log p ( {C}_{1} \vert {W}_{1} ) - log p ( {C}_{2} \vert {W}_{1} ) > 0$$

Using multinominal logistic regression and applying the softmax function used in DALI to the final layer of the DNLN we have:

$$p ( y = i \vert {W}_{1} ) = \frac{{e}^{{w}_{1}} {T}_{{w}_{j}}}{{\sum }_{k = 1}^{k} {e}^{xTwk}}$$

Short-Term Memory (m) Module

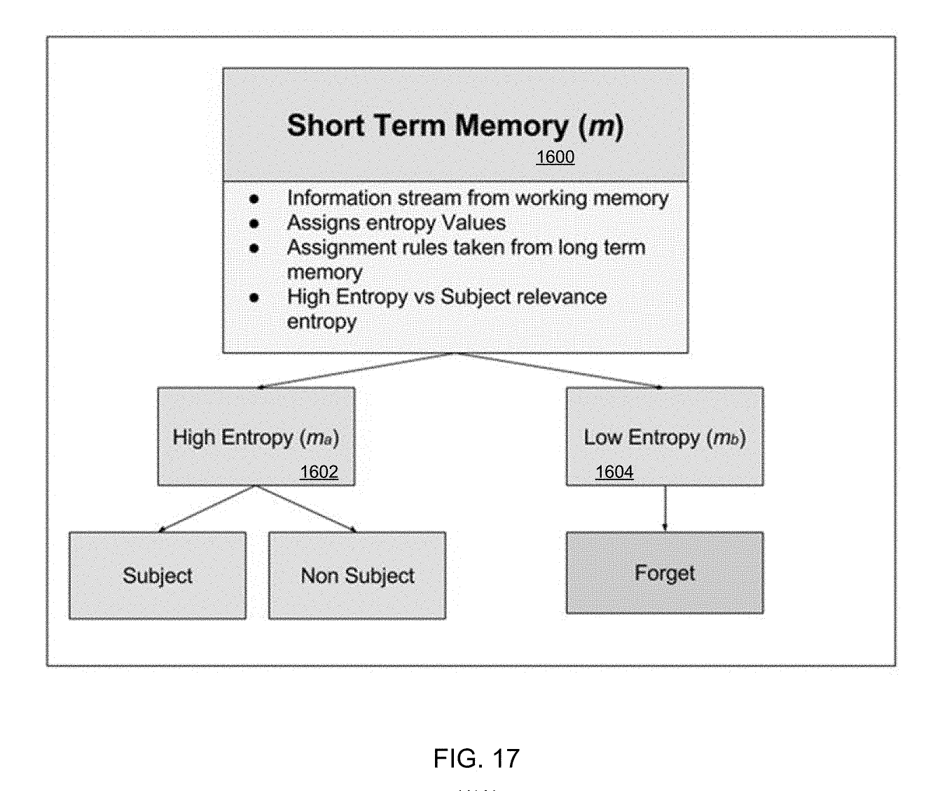

FIG. 17 is a schematic diagram illustrating an exemplary Short-Term Memory (STM) Module 1600 of the KAS 1300. The Short-Term Memory Module (STM) 1600 serves as a filter that allows the Knowledge Acquisition System (KAS) 1300 to either store data for a short period of time, generally >30 s, or delete data (information) by calculating the importance, or ‘entropy,’ of the data. The KAS STM module 1600 is modeled on characteristics of the function of the human memory pre-frontal cortex, so the STM tends to store STM with high emotional value and is more likely to store (remember) negative information (m1) as opposed to positive information (m2), or neutral information (m0) (Kensinger, E. A., & Corkin, S. (2003). Memory enhancement for emotional words: Are emotional words more vividly remembered than neutral words? Memory & Cognition, 31(8), 1169-1180. https://doi.org/10.3758/BF03195800). All forms of communication channel data in an online learning platform are classified as Episodic Inputs 1404, so Episodic Inputs will consist of an extremely vast amount of data with a significant portion that is unusable or lacking of relevant information. This portion of data will be considered unimportant and will be filtered, or forgotten. FIG. 17 outlines The KAS STM Module 1600.

When considering human STM (m), limited neurological memory storage is often regarded as an inhibiting limitation (Baddeley, A. D. (1999). Essentials of human memory. Psychology Press.). With respect to computer memory and information dataset storage, the limitation is trivial. Through web-based cloud storage schemata, an immense amount of data can be stored. However, in certain scenarios, the brain's ability to forget information is actually highly beneficial, such as when the material contained in the information is obsolete or unnecessary, due to trade-offs that occur between processing and storage activities. The more resources the brain allocates to storing information, the less ability it possesses to process the information (Gathercole, 1999). It is a fundamental principle of human memory that some information are remembered and some forgotten (Wagner, A. D., Schacter, D. L., Rotte, M., Koutstaal, W., Maril, A., Dale, A. M., . . . & Buckner, R. L. (1998). Building memories: remembering and forgetting of verbal experiences as predicted by brain activity. Science, 281(5380), 1188-1191). Therefore, within the Knowledge Acquisition System 1300, a similar innovation is desired, even despite large capacity storage servers. By limiting unnecessary data, each Omega Learning Map becomes a more precise tool for guiding a student's learning process.

First, if the input data matches any of the three data fields of W1j, W2j, or W3j, the material is relevant and is categorized as important (high entropy). If not, the module conducts a machine-learning artificial intelligence Sentiment Analysis using already trained models with 200,000 phrases resulting in 12,000 parsed sentences stored in a network tree structure, and weights the dataset with high sentiment as important, and low sentiment as unimportant. Finally, if the dataset has been deemed unimportant, the model performs another content analysis using machine-learning artificial intelligence Emotional Content Analysis models already trained with 25,000 previously tagged phrases resulting in 2000 parsed sentences stored in a network tree structure, and tags datasets with higher amounts of emotion with larger weights. Datasets with high sentiment and/or emotion are considered relevant because they provide emotional context to the dataset content. And may reflect students' underlying motivations (Bradley, M. M., Codispoti, M., Cuthbert, B. N., & Lang, P. J. (2001). Emotion and motivation I: Defensive and appetitive reactions in picture processing. Emotion, 1(3), 276-298. http://dx.doi.org/10.1037/1528-3542.1.3.276).

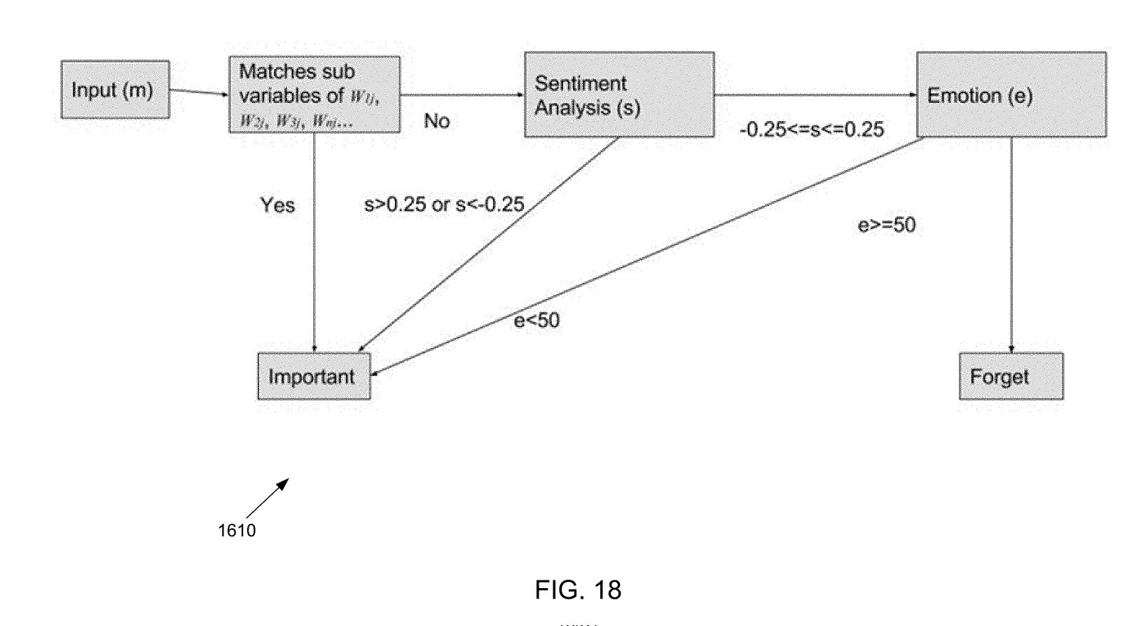

FIG. 18 is a schematic diagram illustrating an exemplary Entropy Filter and Decision Process associated with the STM. The STM module 1600 uses a modified version of the Shannon Entropy Equations (Shannon, C. E. (2001). A mathematical theory of communication. ACM SIGMOBILE Mobile Computing and Communications Review, 5(1), 3-55) and categorizes any data that does not pass these three filters as low entropy and forgets it by deleting it from storage. The system then categorizes all high entropy data as either subject or non-subject matter and passes it to Long-Term Memory (LTM) 1700 where it is stored in the student's ΩLM. FIG. 18. describes the entropy filtering process.

Let dataset input=m, and m can only have one of (s) or (e) values of W₁ⱼ, W₂ⱼ, W₃ⱼ, Wn_{j . . .} , W₍ₛ₊ₑ₎; Y(m=W₁ⱼ)=y₁ⱼ and Y(m=W₂ⱼ)=y₂ⱼ and Y(m=Wnj)=ynj; so, Y(m=W₍ₛ₊ₑ₎)=y₍ₛ₊ₑ₎

### Therefore:

$$H ( m ) = - {y}_{1 j} {log}_{2} {y}_{1 j} - {y}_{2 j} {log}_{2} {y}_{2 j} - … {y}_{nj} {log}_{2} {y}_{nj} … = - {\sum }_{J = 1}^{W} {y}_{( s + e ) j} {log}_{2} {y}_{( s + e ) j}$$

H(m)=the entropy of m
With reference to FIG. 17, high entropy 1602 means mₐ is determined to be high (sentiment and emotionally positive) or low (sentiment and emotionally negative). And m_{b} data that is insignificant (low entropy 1604) would result in a quasi-steady-state mathematically, and become forgetful (deleted).

Long-Term Memory (l) Module

FIG. 19 is a schematic diagram illustrating an exemplary Long-Term Memory (LTM) Module 1700 and is a representation of a semi-permanent memory, e.g., >60 seconds, directed to performing a semi-persistent function (procedural memory), and approximates the memory used for riding a bicycle or remembering a song, a human face, voice, or a math formula (declarative memory). If not for atrophy from aging and/or injury (with a 100×10010 neuron count, with an estimated 108,432 synaptic link count between those neurons), the human LTM capacity is almost unlimited. Due to the immense challenge in trying to simulate a software-based model of human LTM for the purposes of storing and retrieving a student's learning data and associated learning experiences, we used a version of the Object-Attribute-Relation Model of LTM that defines finite datasets used herein. However, we replaced Relation with Association as defined below.
a) Object: The perception of an external entity and the internal concept of that perception;
b) Attribute: a sub-object, or sub-variable in the invention, that is used to define the properties, characteristics, and physiognomies of an object;
c) Association¹: a relationship between a pair or pairs of object-objects, Object-Attributes, or attributes—attributes.
   Therefore: OAA¹=(O, A, A¹);
   Where O is defined as a finite set of objects equal to a sub-variable within a dataset. A is a finite set of attributes equal to a dataset that portrays or illustrates an object. A¹ is a finite set of associations between an object and other objects and associations between them.

The structure of the Omega Learning Map simulates human Declarative Memory which is comprised of both episodic and semantic memory, and possesses the ability of conscious recollection. Episodic memory consists of sequences of events, and semantic memory consists of factual information (Eichenbaum, H. (2000). A cortical-hippocampal system for declarative memory. Nature reviews. Neuroscience, 1(1), 41-50. doi:10.1038/35036213). The Semantic Inputs (Traditional Achievement, Non-traditional Achievement, Foundational Data, Parsed Student Subject and Non-Subject Social Data, and Historical Data from an online learning platform) received directly from the Working Memory 1500 bypass the STM memory module 1600 and are stored in the Semantic Memory component 1802 of the Declarative Memory module 1800 as seen in FIG. 19.

The Episodic Inputs from the Short-Term Memory (STM) 1600 are stored in the Episodic Memory component 1804 of the Declarative Memory Module 1800 as Memory Cells. Episodic Memory cells are classified by various properties 1806, known as Patterns of Activation, Visual/Textual Images, Sensory/Conceptual Inputs, Time Period, and Autobiographical Perspective (Conway, M. A. (2009). Episodic memories. Neuropsychologia, 47(11), 2305-2313. https://doi.org/10.1016/j.neuropsychologia.2009.02.003). As used in the present invention, Episodic memory cells are further characterized with two key innovations: Multidimensional Dynamic Storing and Rapid Forgetting. The invention's Episodic Memory cells within the Declarative Memory Module 1800 allow students to re-experience past learning events through conscious re-experiences, allowing quasi-learning ‘time travel’ (Tulving, E. (2002). Episodic memory: from mind to brain. Annual review of psychology, 53(1), 1-25). An episodic memory cell can be defined as an element of a block within a hidden layer in a machine-learning deep neural network (DNN) model. Each block can contain thousands of memory cells used to train a DNN about a user's experiences associated with a learning event (see Object-Attribute-Association1 Model above). Each Episodic memory cell also contains a filter that manages error flow to the cell, and manages conflicts in dynamic weight distribution.

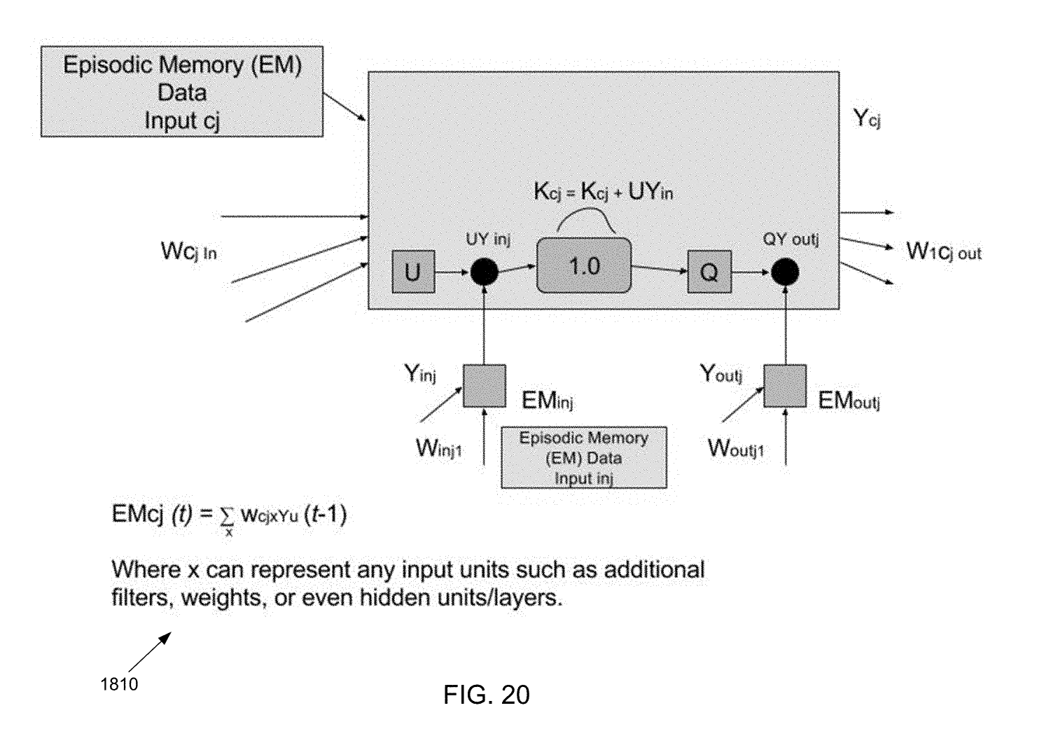

FIG. 20 is a schematic of an exemplary Episodic Memory Cell Model 1810 in accordance with the DMM 1800 of the KAS and Memory Model. FIG. 20 outlines a diagraph demonstrating memory cell input and output data, dynamic input and output weights, and filtering system to manage weight conflicts and error flow.

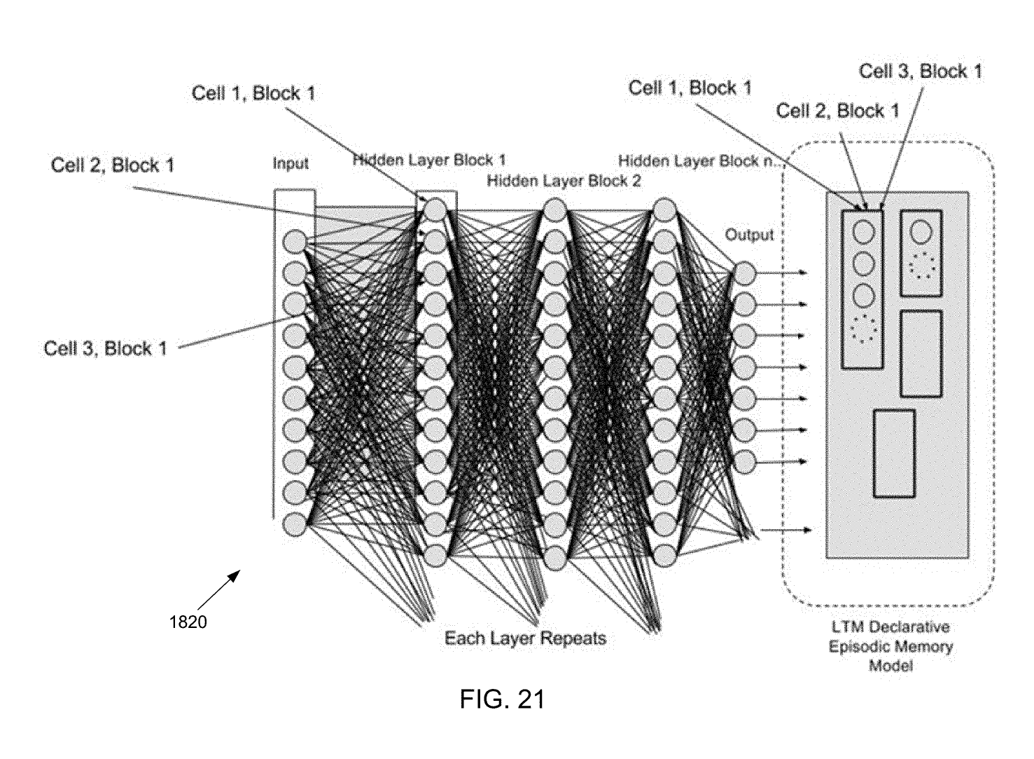

FIG. 21 is a schematic diagram of DALI's Declarative Episodic Memory Blocks and Cells Structure 1820. As mentioned above, an episodic memory cell can be defined as an element of a block within a hidden layer in a machine-learning deep neural network (DNN) model. Each block can contain thousands of memory cells used to train a DNN about a user's experiences associated with a learning event. FIG. 21 outlines the position of a Memory Cell Block within DALI's DNLN Machine Learning Models and the Storage Schemata.

The OLM or ‘ΩLM’ makes use of these cell properties in a similar way by associating sematic memory experiences within an episodic memory rubric that can include related timeframe, patterns of activation, autobiographical perspective, sound, color, and text that all occur within the context of singular learning experience that replicates the human LTM capture and storage, identification and retrieval process.

Procedural Memory Module

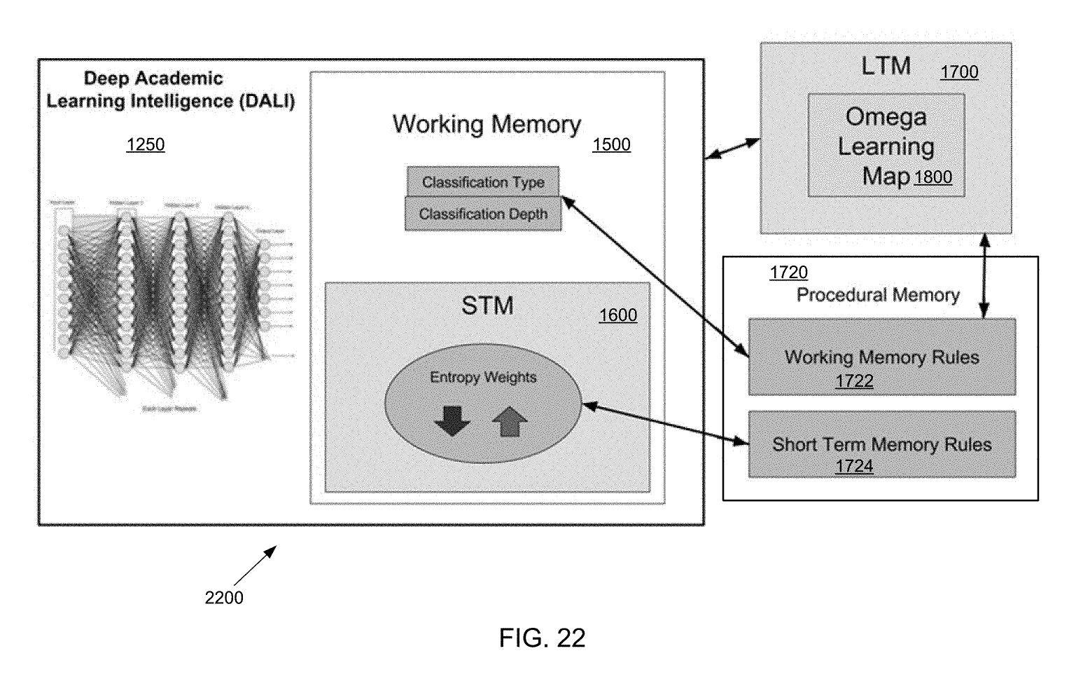

FIG. 22 is a schematic diagram of a memory model 2200 including an optional Procedural Memory Module 1720 as a component of the LTM 1700, which represents a function of acquiring and storing motor skills and habits in the human brain (Eichenbaum, 2000). The Procedural Memory in the ΩLM contains the rules for storage for use in the Working Memory 1500 and STM 1600. Storing the rules in the LTM 1700 allows DALI 1250 to constantly adapt and change them if necessary. Within the Working Memory 1500 specifically, the Procedural Memory 1720 dictates what type of categorizations are made and the depth of categorization needed at any instance. For example, if the amount of incoming data is very large and the buffers for both Working and Sensory Memory are reaching maximum storage capacity, the Procedural Memory indicates to the Working Memory to reduce the depth of classification in return for higher classification speed. One key application of the Procedural Memory is in the STM 1600, where the Procedural Memory 1720 plays a role in changing the weights used to calculate how data is defined as low entropy and/or should be forgotten. The STM has no method of accessing what is already stored within a student's Omega Learning Map, and therefore will have no real insight on what information is missing, or is already stored about a student's learning experience. The Procedural Memory 1720 may be adapted to provide this insight. By communicating with DALI 1250 and a student's Omega Learning Map, the Procedural Memory 1720 informs whether there is a lack of usable information within the student's ΩLM, and then transfers this information to the Short-Term Memory to lessen the restrictions of the entropy filter within that module. The inverse can be performed as well, if the student's ΩLM contains an excess amount of information regarding one specific topic, the weights regarding that topic, could potentially be lowered. The decision whether to lower or to raise the weight's strength is made by DALI after she has parsed and analyzed the data within a student's ΩLM in order to make, or not to make a mentoring, counseling, or advising action. This decision is then communicated with the Procedural Memory to transfer to the STM. In short, the Procedural Memory Module can function as an advisor to the Working and STM Modules to allow for greater flexibility in data storage.

As was previously mentioned, the invention may include a Universal Memory Bank (UMB) 1740, the UMB tags and indexes student parsed data from an integrated cohort vector experience, which is the sum of the DALI suggestions and recommendations responses, and the follow-up Helpful responses that may represent potential universal conditions that another student may experience in the future. DALI also stores the sum of each tagged cohort vector experience, whether successful, or the suggestions and Helpful solicitation was a failure, outside any student's ΩLM, decoupled from any student's silhouette within a generic Long-Term Memory (LTM) schemata. If a tagged cohort vector experience is recognized as similar (parsed, tagged, and indexed) by DALI as another student's conditional experience, she will only provide previously successful recommendation and suggestions to help ameliorate the issue or conflict, thereby using other student's data to solve a different student's similar issue.

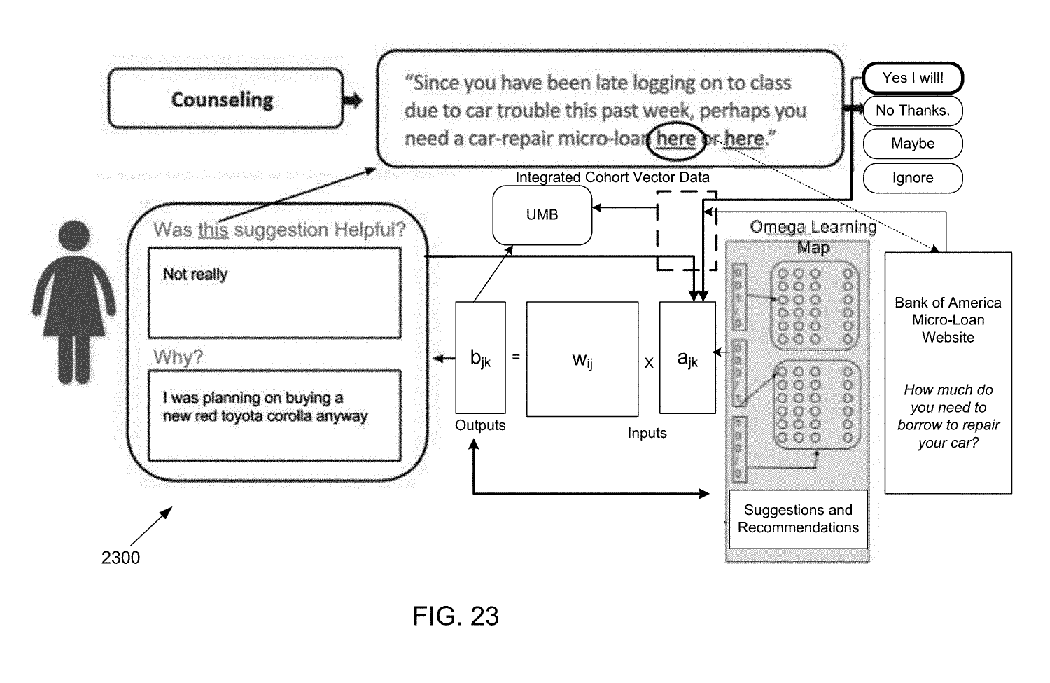

FIG. 23 illustrates a Universal Memory Bank and DALI Suggestion/Helpful Training Loop data flow 2300 showing the function and process of the Universal Memory Bank (UMB). Long-Term Memory Episodic Recall Promoter Apparatus—For the purposes of this invention, the definition of an ERP is an artificial episodic memory apparatus that tempts and attracts a learner into recalling LTM information through multisensory associative exposure and/or condition. The Cognitive ERP apparatus integrates with the Omega Learning Map that contains a learner's declarative memory experiences derived from joint academic, communicative, and social engagement.

Episodic memories consist of multiple sensory data that has been processed and associated together to allow humans to recall events. It is plausible to postulate that memories consist of many interrelated components that represent experiences and information that are stored in tandem in the human brain, and that all of the related components of one thought or experience can be recollected when one is given as an associated ERP.

According to the fragmentation hypothesis, a memory corresponds with a fragment, or subset, of a perceived event (experience). This fragment can be accessed with a cue to obtain all the elements encoded within it (Jones, G. V. (1976). A fragmentation hypothesis of memory: Cued recall of pictures and of sequential position. Journal of Experimental Psychology: General, 105(3), 277-293. http://dx.doi.org/10.1037/0096-3445.105.3.277). For example, in Jones's (1976) study, colored photographs with a specific sequence and an object with a specific color and location were shown to test subjects, and each of those characteristics were tested as cues to determine if the other elements could be recalled as well. According to Jones, using multiple cues is not any more effective than a single cue due to the reflexive nature of memory recall, but can lead to higher overall recall because it increases the chance that one of the cues is stored within the memory fragment. Other memory models include associative recall models. Ross and Bower's (Ross, B. H., & Bower, G. H. (1981). Comparisons of models of associative recall. Memory & Cognition, 9(1), 1-16. https://doi.org/10.3758/BF03196946) study tested the horizontal and schema memory structures in addition to the fragmentation hypothesis. In the horizontal structure, there are direct associations between items in memories that allow recall in one or both directions. The schema model has a central grouping node with connections containing an access probability flowing from every associated item to the node and connections containing a recall probability flowing from the node to every associated item. While the fragmentation hypothesis is a symmetric ‘all-or-none’ model in which items contained within a fragment can be used as a cue to activate all items within the fragment, both the horizontal and schema structures allow for one-way connections between items (objects), and/or attributes of an item.

There is evidence of validity for each of the theoretical models in these studies. Regardless of which model is correct, it can be concluded that there are object attributes and association between these object attributes that form memories, and one object can be utilized as a cue to gain access to other objects. However, in both Jones's (1976) study and Ross and Bower's (1981) study, objects/items were used as cues to recall only other object/items of the same type. Jones's (1976) study mainly used visual cues to test recall of other visual information, with the exception of sequence, which is numerical. Ross and Bower's (1981) study used text to test recall of other text. Because of the ability to contain multiple types of information in episodic memories, different types of information, such as audio and color, may be used as a stimulus to aid in the recall of an element in memory if the element is associated with the cue, and the stimulus is contained within the same episodic memory experience.

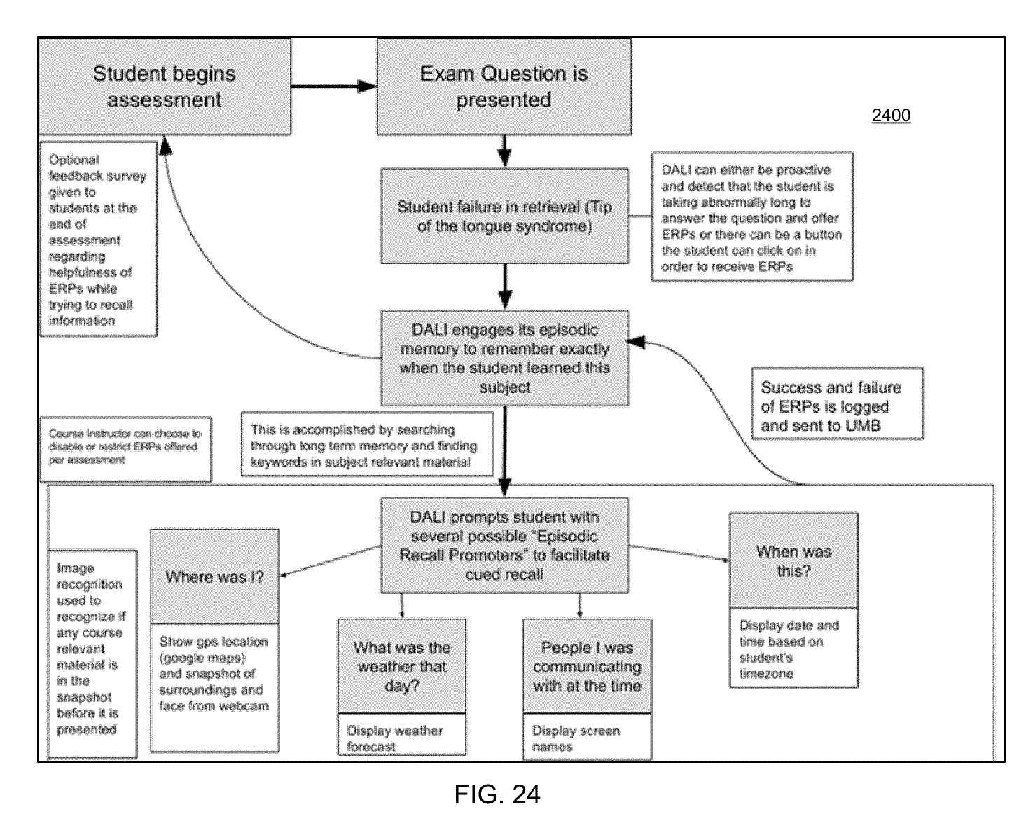

FIG. 24 illustrates a dataflow 2400 representing an Historical Singular Learning Experience Data being Utilized as an ERP to Assist a Student with LTM Recall. One highly effective use of the innovation in the Omega Learning Map is utilizing LTM ERPs to assist students with recall of academic subject matter as they relate to advanced knowledge acquisition. A ERP is an Artificial Episodic Apparatus that tempts and attracts a learner into recalling LTM information through multi-sensory associative exposure and/or condition as shown in FIG. 24. The ERP Apparatus integrates with the software-based ΩLM that contains a learner's declarative memory experiences derived from joint and cohort academic, communicative, and social engagement.

DALI and the ΩLM Integration

As described above, DALI is a deep neural language network (DNLN) matrix×matrix (M×M) machine-learning (ML) artificial intelligence model that provides student academic advising, personal counseling, and individual mentoring data that is available and can be considered in an Aggregate Student Learning (ASL) Environment. Datasets include academic performance history, subject-based and non-subject based communication content understanding, and social and interpersonal behavioral analysis. Over time, DALI will ‘learn’ (be trained) about each student's evolving external environment, condition, state, and situation (non-subject matter) as these impact, or may impact (intrusive) their academic performance within an online learning platform. Upon detecting a potential issue, shared through a communication channel with an instructor or another student or students in their same grouped class and course, DALI will make appropriate corrective suggestions and recommendations to the student to remediate and modify potential negative outcomes. The student trains their DALI DNLN ML model by responding in kind if the recommendation or suggestion was followed, and by the responses received if it was helpful.

Every student's initial grouping data, dynamic regrouping datasets, and every DALI recommendation and suggestion and related responses are passed through the function of the KAS as previously described, the results of which are stored in each student's ΩLM. DALI subsumes the functions of the Working Memory (w) 1500, STM (m) 1600, and the Procedural Memory 1720 Modules of the KAS 1300 as described hereinabove, as the ΩLM 1800 subsumes the function of the Declarative (LTM) Memory Module within the KAS in FIG. 13.

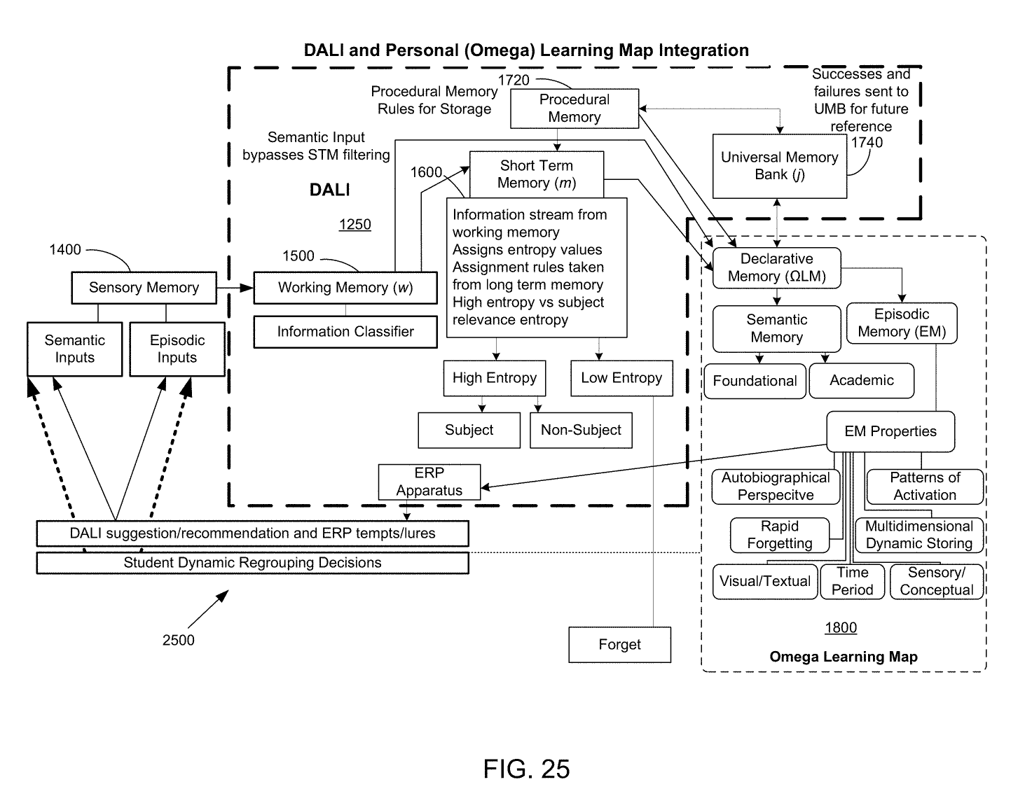

FIG. 25 is a schematic diagram illustrating an exemplary DALI and ΩLM Integration 2500. The integrated system 2500 illustrates the functions and processes of DALI and ΩLM integration. The Procedure Memory Module 1720, from the KAS, is moved within DALI 1250, as the STM Entropy filter rules that determine which datasets to read, write, or forget function as weight and error training datasets, the results which are stored in a students' Omega Learning Map. FIG. 25 also demonstrates the feedback loop of DALI's dynamic regrouping function of students within an online learning platform, DALI's suggestions and recommendations methodology, and the function of the LTM ERP recall invention, within the overall ΩLM invention. Lastly, the Student Sensory Input Module 1400 (originally Sensory Memory in the KAS architecture) functions as the new student data input mechanism, submitting to DALI both Semantic and Episodic datasets as previously defined, as singular and cohort learning experiences to be parsed, tagged, and indexed as such, and then uniquely stored in the Omega Learning Map 1800.

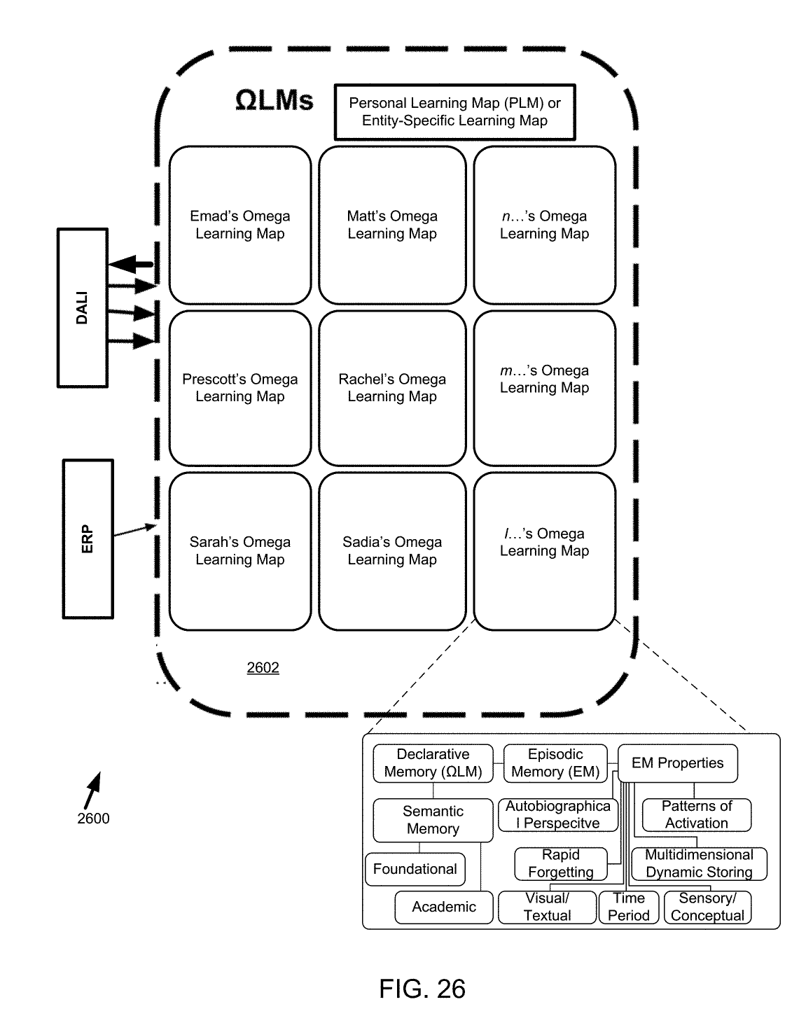

FIG. 26 is a schematic diagram illustrating an exemplary DALI and multiple ΩLM integration implementation 2602. The integrated system 2600 shows a detailed integration and interaction of the numerous student/learners Omega Learning Maps for all students within the online learning platform with DALI. The structure of each Omega Learning Map will be similar for each student and as shown for student i. Every individual's ΩLM will communicate with the singular DALI entity. Each of these distinct and individual ΩLMs will directly receive recommendation advice from DALI based only upon the data within the specific ΩLM and if the conditions warrant, the Universal Memory Bank. DALI also receives feedback from every individual ΩLM about the results of the recommendations and ERP, which are in-turn stored in each student's Omega Map and the Universal Memory Bank.

DALI Implementation, Training, and Features

DALI, as described above, may comprise specifically designed and pre-trained artificial DNLN models that parse, tag, and index combined learner academic subject and non-subject matter communication chat or speech-to-text communication datasets. These academic and social chat datasets, derived from an aggregate student learning (ASL) environment, are analyzed against an academic achievement score matrix in order to detect situational or behavior patterns that may have a negative effect on a learner's academic achievement, and then if detected, suggest a tailored intervention method. ASL is an expansion on the concept of Whole Student Learning, which is generally understood in post-secondary education to be an expansion of the classroom and lab academic experience to also include integrated activities and support from the offices of Student Affairs, Student Counseling, and Student Life in the overall learning plan of a student. ASL combines academic and non-academic (i.e., social) data to measure students' achievement.

In addition, ASL includes additional data points derived from virtually considered student support services such as academic advising, professional mentoring, and even student counseling. Therefore, the DNLN machine deep-learning algorithms can parse all student peer chat and student-to-teacher chat communication from a single platform, or even from multiple integrated communication channels and social media platforms, providing for the differentiation or classification of this data into useful categories for analysis and assessment to gain better insight into the learning process. The topics the learners (students) are chatting about, when they are chatting, to whom they are chatting with, and if and when it may have a positive or negative influence on their academic performance are segmented into specific classifications. To understand the differences between academic and pure social nonacademic chat within an academic learning experience, DALI models are pre-trained about both. In addition, DALI models are configured with a specific academic scoring matrix based on the conversation type, intervention methods, and solutions available to offer a learner.

The machine learning or training process for the DALI models begins with DALI ingesting as an input a course syllabus, using a pre-structured template that includes course overview, learning goals, grading schemata, meeting schedule, and required ‘soft copy’ textbooks. These are all typically found in most robust course syllabi in K-12, higher education, and corporate training. An open source textbook, or one with an open source digital use license is beneficial, as the textbook's content, along with the course syllabus, are used to pre-weight train the DALI academic subject matter models, prior to the launch of a DALI-enabled course. For example, overall content, formulas, diagrams, and learning goals from an Algebra II syllabus will be weighted higher during pre-training for an Algebra II course, while the overall pre-trained and indexed math subject rubric may include Algebra I, II, Geometry, Trigonometry, Calculus I, Calculus II, etc.

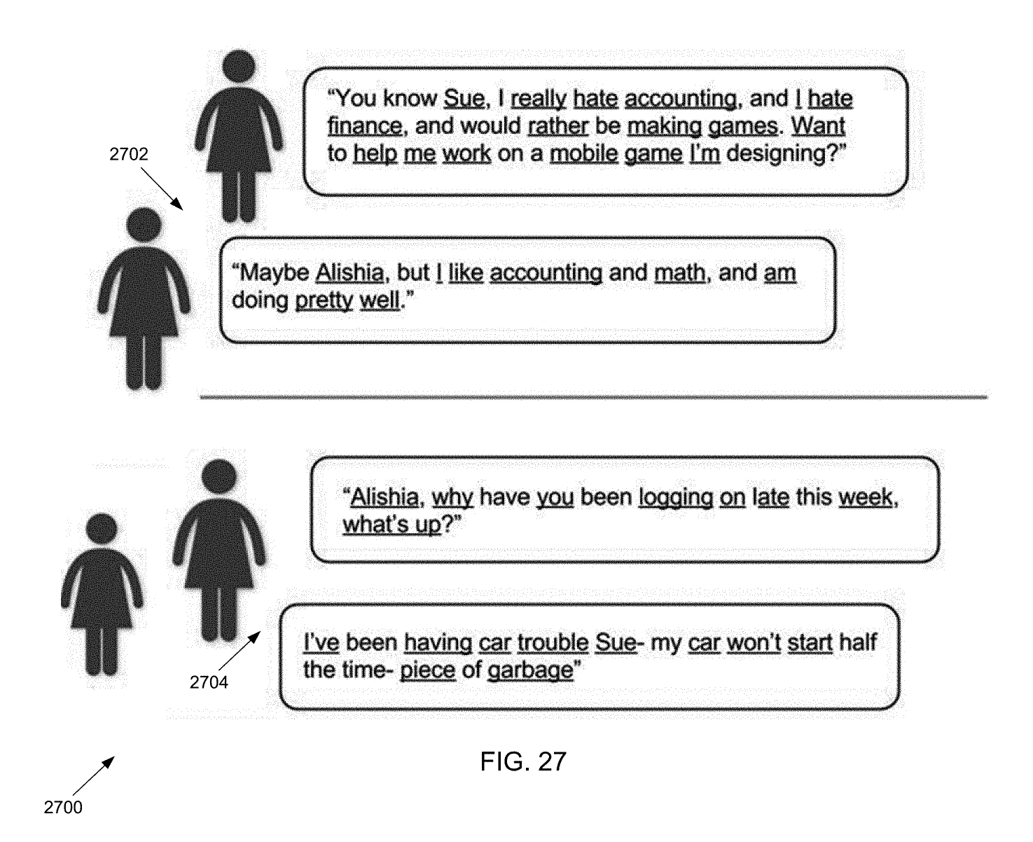

The DALI models are also pre-trained with general structured and unstructured syntactic English language datasets. This provides DALI with the ability to decipher the differences between formal, informal, and slang or colloquialisms. This may be done by digesting as an input publicly available databases such as the community supported and edited Urban Dictionary. The DALI DNLN algorithms comprise multiple integrated pre-trained models in preparation for the launch of an academic course. The deep learning models are designed, programmed, and trained specifically to classify between learner subject and non-subject communication chat. FIG. 27 provides an example of subject-matter 2702 and non-subject matter 2704 parsed text exchange 2700 between two students. In the text exchange 2700 the DALI models and DNLN algorithms parse the text exchange between two students to identify words, phrases, and syntax that may be used to identify the text in the exchange as either subject-matter or non-subject matter text. In the subject-matter exchange 2702, words and phrases used in the exchange identify the content of the exchange as related to a particular course and as being related to particular students. For example, in the exchange 2702 a student remarks that “You know Sue, I really hate accounting, and I hate finance, and would rather be making games. Want to help me work on a mobile game I'm designing?” In the non-subject matter exchange 2704, words and phrases used in the text of the exchange identify the exchange as being a non-subject matter communication. For example, in the exchange 2704 a student remarks that “I've been having car trouble Sue—my car won't start have the time—piece of garbage.”

DALI's indexed student communication and social datasets are weighted against each individual student's academic achievement performance and are analyzed every day of an academic experience. The indexed student communications provide unique insight into the impact social engagement has on learning in a specific academic experience (course). The answers to at least the following questions may be identified by parsing and indexing information contained in communication exchanges, both subject-matter and non-subject matter. Is the non-subject matter interaction between student X and Y in group C having a positive or negative impact on student Y's academic performance? Does the dataset trend line demonstrate that both student X and Y have improved academically since they began helping each other two-months ago? But what else can we use all of this classified, segmented, tagged, and indexed student and student cohort datasets for?

Peer interactivity may strongly influence a student's learning success or be the cause of a student's learning struggles. Subject-matter exchanges coupled with purely social peer interactivity, non-subject matter exchanges, could offer important clues into potential external or tangential issues and conflicts that may have an indirect but adverse effect on the learning process.

With reference again to the exchanges 2700 shown in FIG. 27, in the first exchange 2702, Alishia may be an accounting degree student, but her true interests lie in a potential game design degree major. In the second exchange 2704, Alishia's academic performance may be suffering because of car trouble, making her repeatedly late for her course start time. Both examples 2702 and 2704 indicate some level of virtual student relationship, as semi-private information has been shared from one student to the other. DALI's trained deep-learning models may also harvest parsed and indexed data about not just a learner's academic environment, but also a student's communication styles, social tendencies, personality types, and even emotional state at a moment in time. Alishia's final “piece of garbage” chat closure in the second exchange 2704 would also be detected by a pre-trained emotional and sentiment deep-learning model, and appropriately tagged as ‘anger’ and ‘frustration’ within the exchange context. Based on what information is shared by peers, deep-learning models may also provide a private window into personal and professional external events, conditions, and states that affect a student's learning process, and impact their learning environment—conditions and states that may warrant a learner to seek our professional or academic support structures to remedy their potential negative academic impact.

Within a traditional post-secondary residential education system, if a student's academic standing begins to drop mid-course, there are many remediation options for her in order to address the reasons. A student may schedule office hours with their instructor, visit the tutoring center, seek out advising or counseling center support. Or a student may seek out their faculty mentor, if they are so fortunate to have established one, for guidance and wisdom about how to overcome their challenges. However, existing online education possesses no such options for the struggling student; academic and non-academic environmental circumstances that negatively affect academic success are quite common for non-traditional and historically under-served students pursuing courses and degrees entirely online.

The number of students entering post-secondary education overall is projected to swell, and begin to slowly but more accurately reflect the demographics in the U.S. The need for student support structures to expand and integrate more fully within an academic plan increases with the increase in students. (Hussar, W., Bailey, T. (2014). Projections of Educational Statistics to 2022. National Center for educational Statistics (NCES), Institute of Education Science, U.S. Department of Education. NCES 2014-051. P. 20. Retrieved Apr. 5, 2017, from https://nces.ed.gov/pubs2014/2014051.pdf. incorporated by reference herein in its entirety). As non-traditional, first-generation learners, and historically under-served populations enter post-secondary colleges in greater numbers, and increasingly online, student support structures are needed to ease these new learners' transition into higher education, provide the remedial attention some may require for success, and important academic advising and counseling services. (Abrams, H., & Jernigan, L. (1984). Academic support services and the success of high-risk students. American Educational Research Journal, 21, 261-274, incorporated by reference herein in its entirety). Moreover, the more closely integrated student support services are within the academic curriculum, the more they are proactive, offered earlier during the initial academic experience, sometimes intrusively, the greater the increase in the student retention rate and subsequently matriculation success rate. (Cuseo, J., Fecas, V. S., & Thompson, A. Thriving in College & Beyond: Research-Based Strategies for Academic Success & Personal Development. Dubuque, Iowa: Kendall/Hunt. 2007, incorporated herein by reference in its entirety). In addition, the more aggressive student support initiatives are at implementing intervention and mitigation solutions within the onset of a students' academic struggles, the greater the recovery to academic success. (Tinto, V. (1993). Leaving college: Rethinking the causes and cures of student attrition (2ed.). (pp. 190-185), Chicago: University of Chicago Press, incorporated by reference herein in its entirety). Unfortunately, the primary student of online education has no true student support mechanisms available outside of student-teacher question and answer sessions during class-time, virtual office hours, email, text, or peer group chat forums. Neither option can replace the role of a trained academic advisor, counselor, and mentor that understands each individual student's needs and issues to provide the appropriate support structures they individually require to achieve academic success.

DALI comprises a set of deep-neural language networks that parse, classify, preferably as many as possible, communication and social exchanges that occur within chat communication channels. DALI collects exchange data and analyzes and/or measures that chat analysis against a learner's academic achievement scores. In this manner, DALI generates and provides remedial recommendations specific to individual students in support of pre-trained academic advising, professional and personal counseling interventions, and even individual mentoring to an individual learner.

Derived from massively pre-trained datasets that represent each intervention and support function above, from unsupervised active training from real-time student subject communication and purely social exchanges and interactivity content understanding, DALI can ‘learn’ about each student's evolving external environment, condition, state, and situation as it impacts, or may impact their academic performance. Upon detecting a pre-trained potential issue, DALI may make appropriate corrective or “remedial” recommendations to intervene and remediate and take measures to avoid or mitigate potential negative outcomes. For example, a learner may train their DALI models by responding to an intervention recommendation with a simple click of either “Yes I will”, “No Thanks”, “Maybe”, “Ignore”, and if it was “helpful”. A learner's initial response options from the recommendation are limited to “Yes I will”, “No Thanks”, “Maybe”, “Ignore”, but a follow-on “helpful” solicitation allows DALI to receive an even greater entropy vector to more fully offer accurate and impactful recommendations in the future.

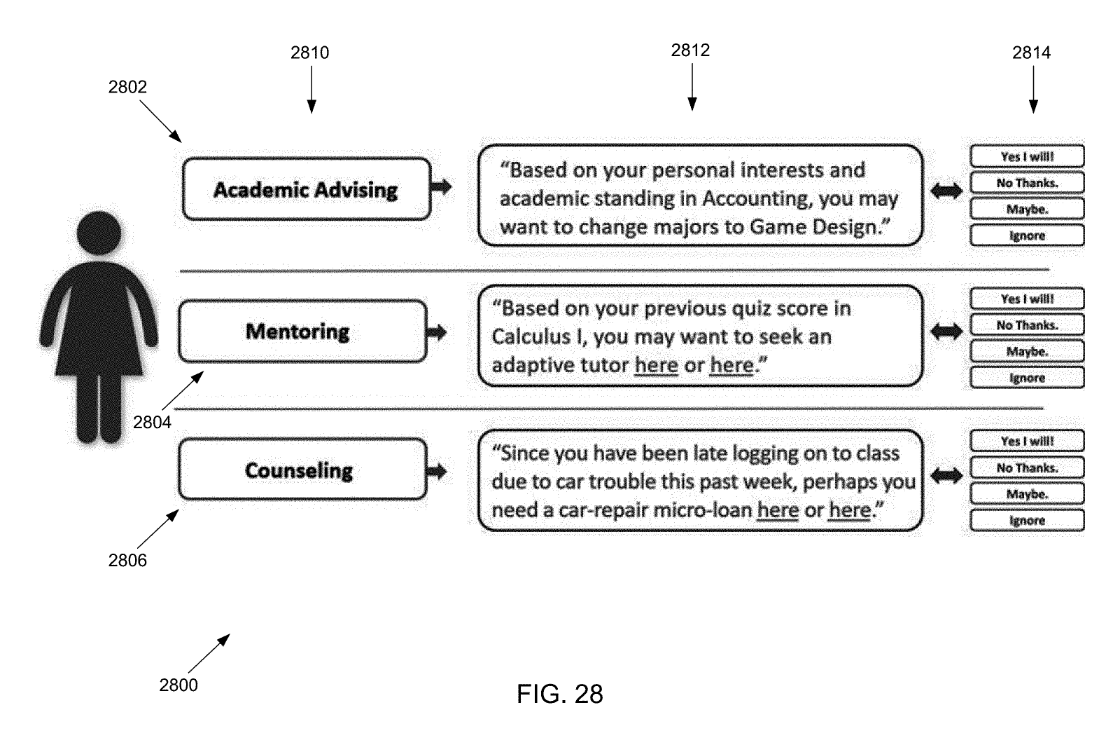

With reference back to FIG. 27, the exchange 2700 between the two students may be viewed from DALI's pre-trained and active training perspective. Alishia does not like her major degree program, hates the course work required, and but does like Game Design. DALI parses the text, matrixes the text against her current grades in the two courses mentioned, Accounting and Finance, and if she scored poorly (measured from pre-trained scale), automatically generates a remedial recommendation or suggestion and transmits a signal representing the generated remedial recommendation to Alisha and/or her professor or counselor suggesting Alisha may want to consider a change of major and may further include the recommendation of Game Design. Based on pre-training, the recommendation is, in this example, an ontological and syntactical process. Also, the college's catalog may be ingested in the DALI models and stored into an integrated database enabling DALI to provide a link to the game design degree online catalog description. Additionally, during the second exchange, DALI can recommend to Alishia a link to her college's pre-approved financial bank that can provide a micro-loan to repair her car. FIG. 28 provides examples of the three AI student support services recommendations 2800 made by the DALI DNLN.

As provided in FIG. 28, a set of recommendations 2800 are provided to a student, Alishia in this example, based on the parsed and indexed exchanges. The three recommendations 2800 fall into one of three exemplary categories 2810 which are academic advising 2802, mentoring 2804, and counseling 2806. Each recommendation 2800 may be presented with a text based prompt 2812 which may comprise a description of the remedial recommendation. The prompt 2812 may further include a link to a useful resource such as a course catalog, website, tutor, or other information related to the recommendation. Each recommendation 2800 is also provided with a set of response options 2814 to provide feedback to the DALI system based on the recommendation provided by DALI. These response options 2814 may include the “Yes I will”, “No Thanks”, “Maybe”, and “Ignore” responses which may be given different weights based on the provided recommendation 2812.

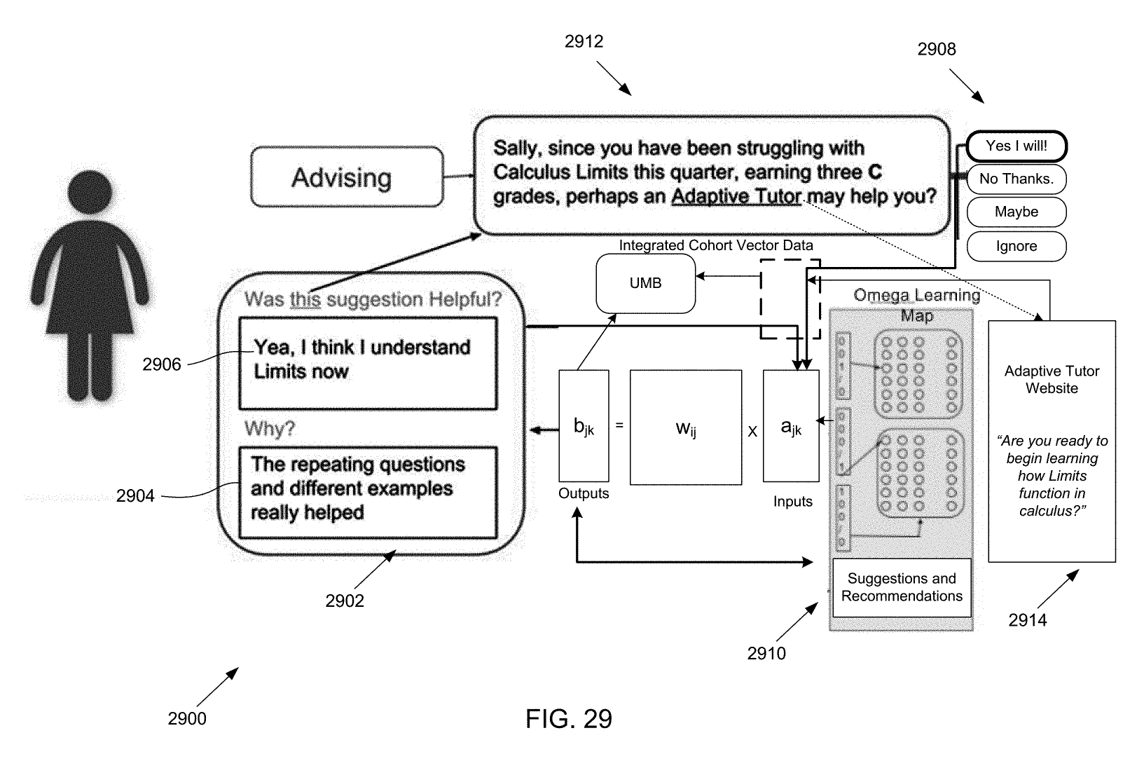

A delayed follow-up “Was This Helpful” solicitation completes the DALI training loop for each recommendation decision made by a learner, and further refines the values of each initial input supplied via the response option 2814. Regardless of which of the four-initial feedback response options 2814 a learner may choose, after a delayed period of time, DALI solicits a further response provided in an additional user interface. This further response may ask the student “Was This Helpful” and “Why” in a set of open text boxes. With the “Helpful” solicitation, DALI connects and passes the initial recommendation function results to a follow-up “Helpful” solicitation as a mathematical cohort, and further possesses more active training data to make future recommendations more precise. “Helpful” text blocks, “Was This Helpful” and “Why”, are parsed in sequence by DALI, and the results are tagged and jointly indexed as an additional cohort and integrated alongside the initial recommendation within the learner's Omega Learning Map (ΩLM), or personal storage database that contains all the elements parsed by DALI from a learner's experience. If the learner chooses not to input any text responses in the “Helpful” solicitation text blocks, a simple “cancel” button is available to close the solicitation. If no text data is received, DALI will send one last solicitation request, and if no input, it will be forgotten. FIG. 29 provides an example of a DALI training loop 2900 comprising a DALI Academic Advising Recommendation 2912, initial response 2908, and then follow-up solicitation 2902 to better train each students DALI models and personal ΩLM. The initial recommendation 2912 is provided to the student based on the parsed, processed, and indexed communication exchange data. The recommendation 2912 may provide a link to additional information or resources 2914 such as an external website, and is also presented with a set of response input options 2908. The student response is stored in the student's personal learning map 2910 which may be the student's personal ΩLM. This information is further indexed and processed to present the student with the follow-up solicitation 2902 comprising the “Was This Helpful” input field 2906 and the “Why” input field 2904. The inputs from the “Was This Helpful” input field 2906 and the “Why” input field 2904 are further parsed, processed, and indexed by DALI and stored in the student's personal ΩLM to complete the training loop 2900 in this example.

Every learner's DALI recommendation and their responses are stored in their personal Omega Learning Map (ΩLM), along with their overall communication and social chat matrix, and their academic achievement records and transcripts. Described in detail hereinabove, the ΩLM is a unique approach to tagging, indexing/storing and retrieving student learning data within an artificial cognitive declarative memory model. The new memory model is greatly assists in useful storage and retrieval of the immense amount of active trained learner material derived from DALI's analysis and processing of complete academic, communication, and social datasets.

The initial decision, made from a recommendation by a learner (“Yes I will”, “No Thanks”, “Maybe”, and “Ignore”) are also weighted within the ΩLM (weighted highest for “Yes I Will”, and proportionally lowered until “Ignore”) and the follow-up solicitation cohorts are then ingested back into and through DALI. (Rumelhart, D., Hinton, G., Williams, R. (1986). Learning Representation by back-propagation errors. Nature V 323, 533-536. doi:10.1038/323533a0, incorporated by reference herein in its entirety). The web link and potential click data are also tagged and jointly indexed all combined and are also stored in a learner's personal ΩLM.

DALI represents just one example of the application of artificial intelligence that can be deployed to provide learners with important individual academic and personal support to help improve their academic journey. Over time, DALI provides additional opportunities to further combine social learning and traditional academic learning to positively impact education. DALI may use the data indexed in the personal learning map to tag some learners as potentially great tutors with certain behavioral attributes and personality traits alongside their academic success, or match ‘natural’ tutors with lower-level struggling learners. The DALI models can also be used to prompt an appropriate upper-level learner to reach out to a lower-level to check-in with them, such as “I see you are struggling in accounting, need any help?” or “Everything ok with your studies, need a tutoring session?” facilitating peer-social support. When ASL datasets are tagged and indexed by a multitude of trained deep-learning models, as in DALI, the options to exploit the datasets to positively impact the teaching and learning process greatly increase. Over time, the indexed individual and grouped class data sets can be harvested to identify individual student communication styles, personality types, attitude and social tendencies combined with interpersonal behavioral attributes within a particular academic environment on any given day. These dynamic human neuropsychological and neurosocialogical attributes, displayed by peers can be captured, measured, and codified by DALI's supervised and unsupervised trained deep-learning models. In this way, DALI can positively influence and affect the learning process and subject matter comprehension of every learner within the micro-society of the classroom.

Depending on the reply and “Helpful” responses made by a student based on the recommendations provided by DALI, and the resultant academic performance improvement or decline, each student's ΩLM will adapt and evolve, allowing DALI to learn more about the value of each suggestion and recommendation to better provide more relevant recommendations, advice, and counsel for each student in the future. FIG. 12 provides a block diagram of DALI integrated with the Networked Activity Monitoring Via Electronic Tools in an Online Group Learning Course and Regrouping Students During the Course Based on The Monitored Activity (U.S. patent application Ser. No. 15/265,579, incorporated by reference herein in its entirety) and an exemplary data collection and distribution loop, including the initial grouping variables, to establish a student's ΩLM and subsequent academic advising, professional mentoring, and personal counseling output and input process throughout an academic journey.

The deep neural language network (DNLN) models used by DALI are able to recognize several words in a category of category of category of words within a particular data set that may be similar in structure, but they can still be encoded separately from each other (Bengio, Y., Ducharme, R., Vincent, P., Jauvin, C. (2003). A Neural Probabilistic Language Model. Journal of Machine Learning Research 3, 1137-1155, incorporated by reference herein in its entirety). Statistically, neural language models share strength between one word, or group of words and phrases and their context, with other similar group of words or phrases and their structured context. The neural natural language model may also be trained so that each word, or series of word or phrase representations is embedded to treat words and phrases that have aspects, components, and meaning similarly in common. The results of these models creates a distributed ontological map. Words and phrases that may appear with similar features, and are thereby treated with similar meaning, are then considered ‘adjoining words’, and can then be semantically mapped accordingly. FIG. 3 provides an example of a simplified distributed representation map (Turian, J., Ratinov, L., Bengio, Y. (2010). Word representations: A simple and general method for semi-supervised learning. Proceedings of the 48th Annual Meeting of the Association for Computational Linguistics, pages 384-394, Uppsala, Sweden, 11-16 Jul. 2010, incorporated by reference herein in its entirety).

Social and behavioral trait data sets are derived from both syntactic analysis using (natural) neural language model analysis of the communication channels data, conforming to the rules of formal, informal, and slang grammar used between the student and other students, and the student and instructor(s). Speech-to-text and image recognition machine-learning model mapping are also employed to parse, tag and index multi-audio/visual live-streaming student group interactivity as well. DALI passes this combined indexed subject and non-subject tagged and indexed data through multiple interleaved machine learning models such as sentiment, intent, Myers Briggs, personas, emotions, intent, and people models, and assigns to each student a personality trait grid of Openness, Conscientiousness, Extraversion, Agreeableness, Neuroticism (Goldberg, L. (1990). An Alternative “Description of Personality”: The Big-Five Factor Structure. Journal of Personality and Social Psychology V59, (6), 1216-1229 American Psychological Association, Inc. 0022-3514/90, incorporated by reference herein in its entirety) each day. Although the quadrants of the personality traits are fixed, the students that convey these traits are not, as individual personality traits evolve through maturation and experiences. FIG. 30 describes elements of the five primary personality traits 3000.

Each personality trait conveys and quantifies different learning styles and learning factors. To provide detailed and focused pre-trained intervention suggestions to a learner, DALI also matches a learner's sentiment and behavior attributes to a preprogrammed Primary Personality Traits grid throughout an academic experience. For example, a learner that exhibits Neuroticism may be constantly chatting about anxiety, nervousness and fear of failing, and therefore needs more reassurance from DALI's intervention recommendations. A learner may exhibit more sociability with extensive non-subject matter pure social chats and may be assertive in answering posted questions demonstrating Extraversion in the Primary Personality Traits grid. If a learner is determined to exhibit one of these traits on the grid, DALI may be triggered to make a more direct and assertive intervention recommendation. As learners fall within the Primary Personality Traits grid for a segment of time, based on either their true personality traits, or external events and states that may affect their personality, DALI will personalize the intervention approach by providing recommendations tailored to the personality trait and other data stored in the learner's personal learning map such as the SLM.

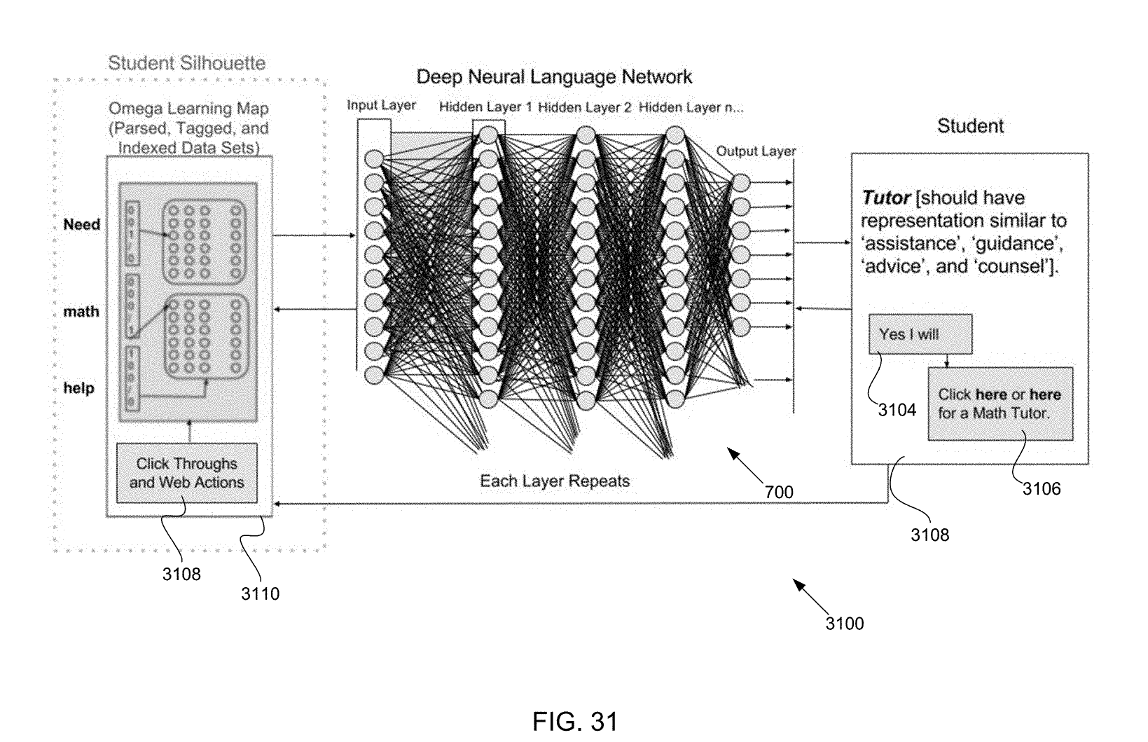

Once the DALI network has been trained about the importance or insignificants of the suggestions and recommendations, and follow-up “Helpful” solicitation results, DALI repeats the training process over again, up to an n number of times. DALI combines the training (learning) methodology of a deep neural language network (DNLN) Matrix×Matrix (M×M) algorithms, with neural language models and dynamically stores and retrieves current and historical student data frames and writes to and from the student's ΩLM. DALI also employs pattern recognition machine-learning models for image recognition of students, and auditory speech-to-text data parsing, tagging, and indexing to store each singular or sequential cohort vector operation in each learner's ΩLM. For each operation, DALI implements 1 million+ hidden layers with 100 million weights to effectively be trained from all the projected data sets and decisions points in each learner's LM. FIG. 31 provides an example 3100 of a DNLN 700 using n . . . number of inputs, with n . . . number of hidden layers and outputs.

The example 3100 in FIG. 31 illustrates a DNLN 700 comprising Matrix×Matrix (M×M) algorithmic back propagation methodology, using final layer Softmax Function scores at an output layer. Softmax Function scores are generally used in the final layer of a deep neural network for reinforcement training, and to reduce the probability of wild swings from variable outliers in the student dynamic regrouping parsed data without deleting the data from DALI and then written to their Omega Learning Map. Below is a generic sigmoid dampening function that limits the potential data swings only between a 1 and 0 value, ensuring that all functions from and to DALI are within a limited range.

$${x}_{i}^{′} ≡ \frac{1}{1 + {e}^{- ( {x}_{i} - {μ}_{i} ) / {σ}_{i}}}$$

DALI employs the Matrix×Matrix (M×M) algorithmic back propagation methodology from Softmax Function scores, but it also uses memory batching. Batching allows for larger memory recalls by reusing previous variable and function weights to improves memory clock operations to take advantage of current and future computer memory management designs and current graphic processing unit capabilities to speed-up mathematical programming operations. The example 3100 also shows how the student's responses 3108 including the initial response 3104 and the follow-up “Helpful” response 3106 are indexed in the student's personal learning map 3110 along with any other tracked information such as click throughs and web actions 3108.

DALI's DNLN and pattern recognition machine-learning model inputs are calculated as Memory Cells. Memory Cells are classified by various properties, known as Patterns of Activation, Visual/Textual Images, Sensory/Conceptual Inputs, Time Period, and Autobiographical Perspective (Conway, M. A. (2009). Episodic memories. Neuropsychologia, 47(11), 2305-2313. https://doi.org/10.1016/j.neuropsychologia.2009.02.003, incorporated by reference herein in its entirety), and the cohort vector integrated storage (derived from DALI's combined suggestions/recommendations, and the Helpful solicitation follow-up). A Memory Cell may be defined as an element of a block within a hidden layer in DALI's deep neural network (DNLN) and pattern recognition machine-learning models. Each block contains thousands of memory cells used to train a DALI about a user's experiences associated with a learning event. Each Memory Cell also contains a filter that manages error flow to the cell, and manages conflicts in dynamic weight distribution. FIG. 20 provides a diagram demonstrating memory cell input and output data, dynamic input and output weights, and a filtering system to manage weight conflicts and error flow. FIG. 21 provides a diagram illustrating the position of a Memory Cell Block within DALI's DNLN Machine Learning Models and the Storage Schemata. The ΩLM makes use of these Memory Cell properties by associating student memory experiences within memory rubric that can include related timeframe, patterns of activation, autobiographical perspective, sound, color, and text that all occur within the context of singular learning experience that assist the data identification and retrieval process.

The various user interfaces described herein may take the form of web pages, smartphone application displays, MICROSOFT WINDOWS or other operating system interfaces, and/or other types of interfaces that may be rendered by a client device. As such, any appearance or depictions of various types of user interfaces provided herein are illustrative purposes.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims as may be amended.

What is claimed is:

1. A system for monitoring and aggregating, via a network, academic performance information and social non-academic performance information derived from electronic communications of students participating in an online group learning course during a course term and generating a set of student remedial recommendations specific to individual students, the system comprising:
a computer system comprising one or more physical processors adapted to execute machine readable instructions stored in an accessible memory, the computer system adapted to:
collect data related to a group of students and organize data into a set of historical data sets, and group students for an online group learning course based in part on the organized data;
generate a first personal learning map (PLM) comprising data sets for a first student based on a first historical data set associated with the first student;
during the course term, collect additional data related to the first student and organize the additional data into a first current data set and update the first PLM based on the first current data set, the additional data collected related to both academic subject matter related activity and non-academic subject matter related activity;
apply the first PLM data sets as inputs to a Deep Neural Language Network (DNLN) and generate as outputs from the DNLN a first set of recommendations for presenting to the first student;
generate a first student user interface comprising the first set of recommendations and a first set of user response elements;
transmit, via a network, the first student user interface to a machine associated with the first student; and
receive a signal representing a user response to the first set of recommendations.

2. The system of claim 1, wherein the computer system is further adapted to update the first PLM to reflect the received user response.

3. The system of claim 1, wherein the computer system is further adapted to input data from the first PLM including data related to the first set of recommendations and the received user (student) response as feedback into a machine-learning process associated with the DNLN.

4. The system of claim 3, wherein the computer system is further adapted to calculate hidden layer errors in the DNLN and alter the DNLN based on the user (student) feedback.

5. The system of claim 4, wherein the computer system is further adapted to alter the DNLN by changing weights associated with one or more hidden layers.

6. The system of claim 1, further comprising a set of student remediation modules including one or more of academic advising, professional mentoring, and personal counseling, and wherein the set of recommendations relates to one or more of the student remediation modules.

7. The system of claim 1, wherein the collected data includes data collected and entered manually through a user interface in communication with the computer system, the user interface being operated by one or more of a student, a teacher, an academic advisor, a counselor, or mental health administrator.

8. The system of claim 1, wherein the computer system employs one or more of the following techniques: logistic regression analysis, natural language processing, softmax scores utilization, batching, Fourier transform analysis, pattern recognition, and computational learning theory.

9. The system of claim 1, wherein the computer system is further adapted to:
generate a second student user interface comprising a second set of user response elements;
transmit, via a network, the second student user interface to a machine associated with the first student; and
receive a signal representing a user response to the second set of recommendations.

10. The system of claim 1, wherein the first set of recommendations comprise remedial recommendations.

11. The system of claim 1, wherein the first set of recommendations comprise intervention recommendations.

12. The system of claim 1, wherein the additional data comprises aggregate student learning data.

13. The system of claim 12, wherein the aggregate student learning data comprises a set of communication information derived from a set of conversations and interactions between the first student and a set of other users.

14. The system of claim 1, wherein the computer system is trained using a machine learning process on a set of input data, the set of input data comprising one or more selected from the group consisting of: a set of course syllabuses, and a set of course textbooks, a set of structured English language datasets, and a set of unstructured English language datasets.

15. The system of claim 1, wherein the computer system is trained using a machine learning process on a set of input data, the set of input data comprising one or more selected from the group consisting of: a set of structured English language datasets, and a set of unstructured English language datasets.

16. The system of claim 15, wherein the set of structured English language datasets comprises a slang language dataset.

17. The system of claim 1, wherein the computer system is trained using an unsupervised active training process, wherein input for the unsupervised active training process is provided by real-time student subject communication monitoring and social interactivity content understanding.

18. The system of claim 1, wherein the user response to the first set of recommendations comprises one selected from the group consisting of: yes, no, maybe, and ignore.

19. The system of claim 9, wherein the second student user interface comprises a set of feedback user interface elements, the set of feedback user interface elements comprising a “Was this Helpful” input and a “Why” input.

20. A computer-implemented method for monitoring and aggregating, via a network, academic performance information and social non-academic performance information derived from electronic communications of students participating in an online group learning course during a course term and generating a set of student remedial recommendations specific to individual students, the method comprising:
collecting, by a computer system comprising one or more physical processors adapted to execute machine readable instructions stored in an accessible memory, data related to a group of students;
organizing, by the computer system, data into a set of historical data sets;
grouping, by the computer system, students for an online group learning course based in part on the organized data;
generating, by the computer system, a first personal learning map (PLM) comprising data sets for a first student based on a first historical data set associated with the first student;
collecting during the course term, by the computer system, additional data related to the first student;
organizing, by the computer system, the additional data into a first current data set;
updating, by the computer system, the first PLM based on the first current data set, the additional data collected related to both academic subject matter related activity and non-academic subject matter related activity;
applying, by the computer system, the first PLM data sets as inputs to a Deep Neural Language Network (DNLN);
generating, by the computer system, as outputs from the DNLN a first set of recommendations for presenting to the first student;
generating, by the computer system, a first student user interface comprising the first set of recommendations and a first set of user response elements;
transmit, by the computer system via a network, the first student user interface to a machine associated with the first student; and
receiving, by the computer system, a signal representing a user response to the first set of recommendations.
